(19) United States
(12) Patent Application Publication
(10) Pub. No.: US 2026/0273479 A1
(43) Pub. Date: Sep. 17, 2026

(54) SEPARATION MEMBRANE

(71) Applicant: NITTO DENKO CORPORATION, Ibaraki-shi, Osaka (JP)

(72) Inventor: Kenji SASAHARA, Ibaraki-shi, Osaka (JP)

(21) Appl. No.: 19/168,560

(22) PCT Filed: Feb. 7, 2024
(86) PCT No.: PCT/JP2024/004215

§ 371 Date: Sep. 24, 2025

(30) Foreign Application Priority Data
Mar. 28, 2023 (JP) 2023-051030

(51) Int. Cl. B01D 71/64; B01D 53/22; B01D 69/02; B01D 69/10

(52) U.S. Cl. CPC B01D 71/64; B01D 53/228; B01D 69/02; B01D 69/1071; B01D 2256/10; B01D 2257/504; B01D 2325/04

(57) ABSTRACT

The present invention provides a new separation membrane suitable for a membrane separation device (particularly a spiral membrane element). The separation membrane includes: a separation functional layer; a porous support member supporting the separation functional layer; and an intermediate layer disposed between the separation functional layer and the porous support member. The porous support member has a surface facing the intermediate layer. A load area ratio Smr(c₁) of the surface determined by a test below is less than 80%. Test: The surface of the porous support member is subjected to a three-dimensional analysis to obtain a load curve prescribed in JIS B0681-2:2018. On the load curve, a height c₁ whose difference from a height co at a load area ratio of 0% is equal to a thickness of the intermediate layer is determined. A load area ratio corresponding to the height c₁ is read and determined as Smr(c₁).

### TECHNICAL FIELD

The present invention relates to a separation membrane.

### BACKGROUND ART

A membrane separation method has been developed as a method for separating an acid gas such as carbon dioxide from a gas mixture containing the acid gas. The membrane separation method allows an efficient separation of an acid gas with a suppressed operation cost, compared with an absorption method according to which an acid gas contained in a gas mixture is absorbed by an absorbent to be separated.

Separation membranes used in the membrane separation method include a composite membrane in which a separation functional layer is formed on a porous support member. As the porous support member, a laminate in which a microporous layer is stacked on a surface of a nonwoven fabric is usually used (Patent Literature 1, for example).

### CITATION LIST

### Patent Literature

Patent Literature 1: JP 6186286 B

### SUMMARY OF INVENTION

### Technical Problem

There is a demand for a new separation membrane suitable for a membrane separation device (particularly a spiral membrane element).

### Solution to Problem

The present invention provides a separation membrane including:
a separation functional layer;
a porous support member supporting the separation functional layer; and
an intermediate layer disposed between the separation functional layer and the porous support member, wherein
the porous support member has a surface S1 facing the intermediate layer, and
a load area ratio Smr(c₁) of the surface S1 determined by a test below is less than 80%.

Test: The surface S1 of the porous support member is subjected to a three-dimensional analysis to obtain a load curve prescribed in Japanese Industrial Standards (JIS) B0681-2:2018. On the load curve, a height c₁ whose difference from a height c₀ at a load area ratio of 0% is equal to a thickness of the intermediate layer is determined. A load area ratio corresponding to the height c₁ is read and determined as the load area ratio Smr(c₁).

The present invention further provides a separation membrane including:
a separation functional layer;
a porous support member supporting the separation functional layer; and
an intermediate layer disposed between the separation functional layer and the porous support member, wherein
the separation membrane has a thickness of 130 μm or less, and
a retention ratio of a separation factor a of the separation membrane is 70% or more when the separation membrane is exposed, for 5 minutes, to nitrogen having a pressure of 2.0 MPa,

the separation factor a referring to a ratio T_{CO2}/T_{N2} of a permeance T_{CO2} (GPU) of carbon dioxide permeating through the separation membrane when carbon dioxide having a pressure of 0.6 MPa is supplied to a space adjacent to one surface of the separation membrane with respect to a permeance T_{N2} (GPU) of nitrogen permeating through the separation membrane when nitrogen having a pressure of 0.6 MPa is supplied to the space.

### Advantageous Effects of Invention

The present invention can provide a new separation membrane suitable for a membrane separation device (particularly a spiral membrane element).

### BRIEF DESCRIPTION OF DRAWINGS

FIG. 1 is a cross-sectional view illustrating schematically a separation membrane according to one embodiment of the present invention.

FIG. 2 is a graph for explaining a method for determining a load area ratio Smr(c₁).

FIG. 3 is a schematic cross-sectional view of a membrane separation device including the separation membrane of the present invention.

FIG. 4 is a perspective view illustrating schematically a modification of the membrane separation device including the separation membrane of the present invention.

### DESCRIPTION OF EMBODIMENTS

A separation membrane according to a first aspect of the present invention includes:
a separation functional layer;
a porous support member supporting the separation functional layer; and
an intermediate layer disposed between the separation functional layer and the porous support member, wherein
the porous support member has a surface S1 facing the intermediate layer, and
a load area ratio Smr(c₁) of the surface S1 determined by a test below is less than 80%.

Test: The surface S1 of the porous support member is subjected to a three-dimensional analysis to obtain a load curve prescribed in Japanese Industrial Standards (JIS) B0681-2:2018. On the load curve, a height c₁ whose difference from a height c₀ at a load area ratio of 0% is equal to a thickness of the intermediate layer is determined. A load area ratio corresponding to the height c₁ is read and determined as the load area ratio Smr(c₁).

According to a second aspect of the present invention, for example, in the separation membrane according to the first aspect, the load area ratio Smr(c₁) is 0.04% or more.

According to a third aspect of the present invention, for example, the separation membrane according to the first or second aspect has a thickness of 130 μm or less.

A separation membrane according to a fourth aspect of the present invention includes:
a separation functional layer;
a porous support member supporting the separation functional layer; and
an intermediate layer disposed between the separation functional layer and the porous support member, wherein
the separation membrane has a thickness of 130 μm or less, and
a retention ratio of a separation factor α of the separation membrane is 70% or more when the separation membrane is exposed, for 5 minutes, to nitrogen having a pressure of 2.0 MPa,
the separation factor α referring to a ratio T_{CO2}/T_{N2} of a permeance T_{CO2} (GPU) of carbon dioxide permeating through the separation membrane when carbon dioxide having a pressure of 0.6 MPa is supplied to a space adjacent to one surface of the separation membrane with respect to a permeance T_{N2} (GPU) of nitrogen permeating through the separation membrane when nitrogen having a pressure of 0.6 MPa is supplied to the space.

According to a fifth aspect of the present invention, for example, in the separation membrane according to any one of the first to fourth aspects, the porous support member is a fiber structure.

According to a sixth aspect of the present invention, for example, in the separation membrane according to any one of the first to fifth aspects, the porous support member has a thickness of 125 μm or less.

According to a seventh aspect of the present invention, for example, in the separation membrane according to any one of the first to sixth aspects, the porous support member has an ISO air permeability of 10.0×10⁴ μm/(Pa·s) or more.

According to an eighth aspect of the present invention, for example, in the separation membrane according to any one of the first to seventh aspects, the separation functional layer includes polyimide.

According to a ninth aspect of the present invention, for example, in the separation membrane according to the eighth aspect, the polyimide includes a structural unit derived from a tetracarboxylic dianhydride having a six-membered ring acid anhydride structure.

According to a tenth aspect of the present invention, for example, in the separation membrane according to the ninth aspect, the structural unit is represented by formula (A1) below:

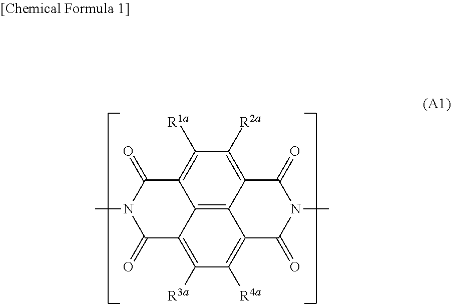

where R^{1a} to R^{4a} are each independently a hydrogen atom or an optional substituent.

According to an eleventh aspect of the present invention, for example, in the separation membrane according to any one of the first to tenth aspects, the separation functional layer has a thickness of 5.0 μm or less.

According to a twelfth aspect of the present invention, for example, in the separation membrane according to any one of the first to eleventh aspects, the intermediate layer is formed from a pressure-sensitive adhesive composition.

According to a thirteenth aspect of the present invention, for example, in the separation membrane according to the twelfth aspect, the pressure-sensitive adhesive composition includes a silicone-based polymer.

According to a fourteenth aspect of the present invention, for example, in the separation membrane according to any one of the first to thirteenth aspects, the intermediate layer has a thickness of 5.0 μm or less.

According to a fifteenth aspect of the present invention, for example, in the separation membrane according to any one of the first to fourteenth aspects, a peel strength between the intermediate layer and the porous support member is 0.25 N/25 mm or more.

The present invention will be described in detail below. The following description is not intended to limit the present invention to a specific embodiment.

### <Embodiment of Separation Membrane>

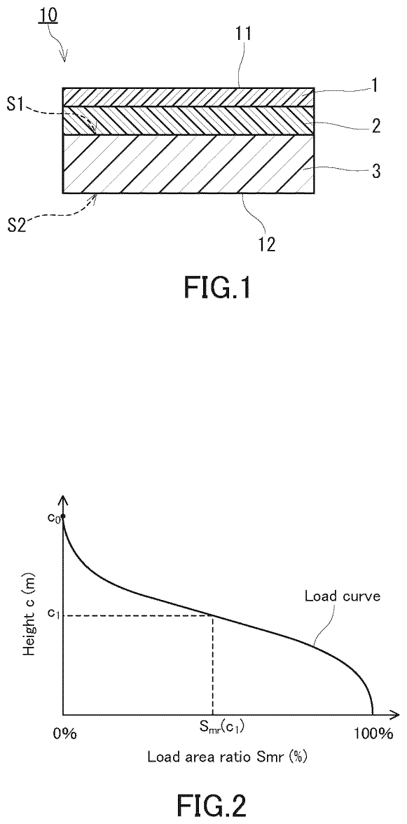

As shown in FIG. 1, a separation membrane 10 of the present embodiment includes a separation functional layer 1, a porous support member 3 supporting the separation functional layer 1, and an intermediate layer 2 disposed between the separation functional layer 1 and the porous support member 3. The intermediate layer 2 is preferably in direct contact with each of the separation functional layer 1 and the porous support member 3.

The porous support member 3 has surfaces S1 and S2 facing each other. The surface S1 faces the intermediate layer 2, and specifically is in direct contact with the intermediate layer 2. In the present embodiment, a load area ratio Smr(c₁) of the surface S1 determined by a test below is less than 80%.

Test: The surface S1 of the porous support member is subjected to a three-dimensional analysis to obtain a load curve prescribed in JIS B0681-2:2018. On the load curve, a height c₁ whose difference from a height c₀ at a load area ratio of 0% is equal to a thickness of the intermediate layer is determined. A load area ratio corresponding to the height c₁ is read and determined as the load area ratio Smr(c₁).

Specifically, the load area ratio Smr(c₁) can be measured by the following method. First, the porous support member 3 taken out from the separation membrane 10, or the porous support member 3 to be used for producing the separation membrane 10 is prepared. The porous support member 3 is cut into the size of 1 cm in length and 1 cm in width to obtain a specimen. The surface S1 of the specimen is observed with a laser microscope. The observation with a laser microscope can be performed under the following conditions.

### Observation Conditions

Light source wavelength: 546 nm
Resolution: 0.1 μm
Observation area: 600 μm×600 μm

Next, a three-dimensional analysis is conducted using the obtained observation image. The three-dimensional analysis can be conducted using LMeye7 as a software and also using FinePeak as an analysis algorithm. Through the three-dimensional analysis, the load curve prescribed in JIS B0681-2:2018 can be obtained (FIG. 2). In a coordinate system in which a vertical axis indicates a height c (μm) of the surface S1 (specifically depressions and projections present on the surface S1) and the horizontal axis indicates a percentage (a load area ratio Smr (%)) of an area where the porous support member 3 is present in a region at a specific height c or higher, the load curve is a curve showing a relation between the height c and the load area ratio Smr.

Next, as shown in FIG. 2, a height c₀ at a load area ratio Smr of 0% (that is, at a position of an outermost surface of the surface S1) is determined, and furthermore a height c₁ whose difference from the height c₀ is equal to the thickness of the intermediate layer 2 is determined. That is, in FIG. 2, the difference |c₀−c₁| between the height c₀ and the height c₁ is equal to the thickness of the intermediate layer 2. The load area ratio corresponding to the height c₁ is read and determined as the load area ratio Smr(c₁).

The load area ratio Smr(c₁) can be used as an index as to pores (openings) present on the surface S1 of the porous support member 3. Specifically, it means that the lower the load area ratio Smr(c₁) is, the more pores with a relatively large diameter are present on the surface S1 of the porous support member 3. For example, in the case where the porous support member 3 has no microporous layer and is composed only of a fiber structure, the load area ratio Smr(c₁) tends to be less than 80%, particularly 50% or less.

The load area ratio Smr(c₁) of the surface S1 of the porous support member 3 may be less than 80% as mentioned above, or may be 70% or less, 60% or less, 50% or less, 40% or less, 30% or less, 20% or less, 10% or less, 5.0% or less, 3.0% or less, 1.0% or less, 0.5% or less, or even 0.1% or less. The lower limit of the load area ratio Smr(c₁) is, for example, 0.01% or more, and may be 0.04% or more. Particularly, when the load area ratio Smr(c₁) is 0.04% or more, the peel strength between the porous support member 3 and the intermediate layer 2 is sufficiently high, making it easy to produce the separation membrane 10 by the later-described transfer method.

### (Separation Functional Layer)

The separation functional layer 1 preferably allows an acid gas contained in a gas mixture to preferentially permeate therethrough, and is typically a dense layer (nonporous layer) in which no pores can be found when observed with a scanning electron microscope (SEM) at a magnification of 5000.

The separation functional layer 1 typically includes a resin. Examples of the resin included in the separation functional layer 1 include a polyether block amide resin, a polyamide resin, a polyether resin, a polyimide resin, a cellulose acetate resin, a silicone resin, and a fluorine resin.

The separation functional layer 1 preferably includes polyimide, and particularly preferably includes polyimide P including a structural unit A1 derived from a tetracarboxylic dianhydride a1 having a six-membered ring acid anhydride structure S. Preferably, the polyimide P further includes a structural unit B1 derived from diamine b1. At least one of the structural unit A1 and the structural unit B1 preferably has at least one functional group f selected from the group consisting of a carboxyl group, a hydroxyl group, a thiol group, and metal salts of these groups, and preferably has a metal salt (particularly a metal salt of a carboxyl group) as the functional group f. Particularly, the structural unit B1 preferably has the functional group f in the polyimide P. The structural unit A1 may or may not have the functional group f.

The structural unit A1 derived from the tetracarboxylic dianhydride a1 is a structural unit suitable for improving the permeability and permeance of an acid gas permeating through the separation functional layer 1. It is preferable that the tetracarboxylic dianhydride a1 have one or more, preferably two acid anhydride structures S. The six-membered ring acid anhydride structure S is typically a glutaric anhydride structure represented by formula (1) below.

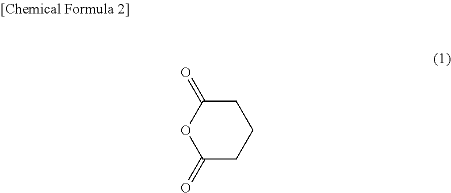

The tetracarboxylic dianhydride a1 may further have at least one functional group g selected from the group consisting of a carboxyl group, a hydroxyl group, and a thiol group, or may not have the functional group g. Note that in the present description, the functional group g is the same as the functional group f except that the metal salts are not included in its options.

The tetracarboxylic dianhydride a1 may have a fused ring, and the fused ring may include the acid anhydride structure S. The fused ring may include an aromatic ring in addition to the acid anhydride structure S. The aromatic ring included in the fused ring may be composed only of carbon atoms, or may be a heteroaromatic ring including a hetero atom such as an oxygen atom, a nitrogen atom, or a sulfur atom. The aromatic ring may be polycyclic or monocyclic. The number of carbon atoms in the aromatic ring is, for example, but not particularly limited to, 4 to 14. Specific examples of the aromatic ring include a benzene ring, a naphthalene ring, an anthracene ring, a phenanthrene ring, a furan ring, a pyrrole ring, a pyridine ring, and a thiophene ring.

The fused ring may or may not have a substituent. The substituent of the fused ring is not particularly limited, and examples thereof include a halogen group and a hydrocarbon group. Examples of the halogen group include a fluoro group, a chloro group, a bromo group, and an iodine group. The number of carbon atoms in the hydrocarbon group is, for example, but not particularly limited to, 1 to 15. Examples of the hydrocarbon group include an alkyl group such as a methyl group, an ethyl group, or a propyl group. The hydrocarbon group may be a halogenated hydrocarbon group in which a hydrogen atom has been substituted by a halogen group. In the case where the fused ring has a plurality of substituents, the substituents may be identical to or different from each other.

The tetracarboxylic dianhydride a1 is preferably represented by formula (a1) below.

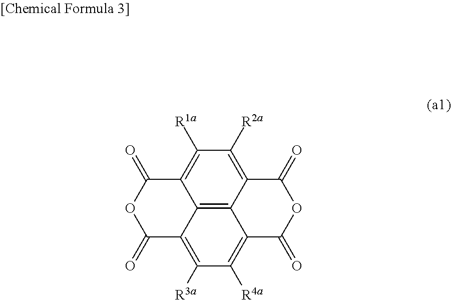

In the formula (a1), R^{1a} to R^{4a} are each independently a hydrogen atom or an optional substituent. The optional substituent is not particularly limited, and examples thereof include a halogen group and a hydrocarbon group. As the halogen group and the hydrocarbon group, those stated above can be mentioned.

In the polyimide P, the structural unit A1 derived from the tetracarboxylic dianhydride a1 is preferably represented by formula (A1) below. The structural unit A1 represented by the formula (A1) is derived from the tetracarboxylic dianhydride a1 represented by the above-mentioned formula (a1). Note that in the formula (A1), a nitrogen atom included in an imide group is derived from diamine that has reacted with the tetracarboxylic dianhydride a1.

### [Chemical Formula 4]

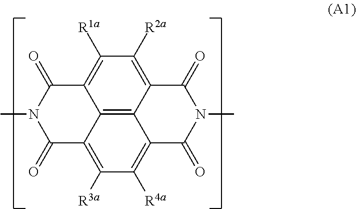

In the formula (A1), R^{1a} to R^{4a} are the same as in the formula (a1) and each independently a hydrogen atom or an optional substituent. As a specific example of the structural unit A1 represented by the formula (A1), formula (A1-1) below can be mentioned.

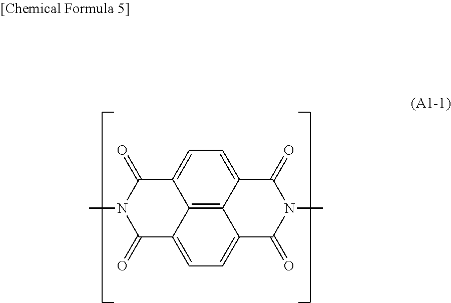

In the polyimide P, a ratio p1 of an amount of substance of the above-mentioned structural unit A1 with respect to an amount of substance of all structural units A derived from a tetracarboxylic dianhydride is, for example, 50 mol % or more, and may be 70 mol % or more, 90 mol % or more, 95 mol % or more, or even 99 mol % or more. The polyimide P may only include the above-mentioned structural unit A1 as the structural unit A derived from the tetracarboxylic dianhydride. Note that the polyimide P may further include, besides the structural unit A1, a structural unit A2 derived from a tetracarboxylic dianhydride a2 having a five-membered ring acid anhydride structure. The tetracarboxylic dianhydride a2 is not particularly limited, and examples thereof include pyromellitic dianhydride and 4,4′-(hexafluoroisopropylidene)diphthalic anhydride.

The structural unit B1 derived from the diamine b1, especially the structural unit B1 having the functional group f, is a structural unit suitable for improving the selectivity for the acid gas permeating through the separation functional layer 1. The diamine b1 is preferably a compound that has two primary amino groups and further has at least one functional group g selected from the group consisting of a carboxyl group, a hydroxyl group, and a thiol group. The number of the functional groups g in the diamine b1 is, for example, but not particularly limited to, 5 or less, and preferably 2 or less, and particularly preferably 1. The smaller the number of the functional groups g in the diamine b1 is, the more the solubility of the polyimide P tends to be improved and the more easily a desirable method for manufacturing the separation membrane 10 tends to be adopted.

The above-mentioned functional group g has a dissociative proton and can form a salt with a counter cation. Particularly, from the viewpoint of forming a salt easily, it is preferable that the diamine b1 have a carboxyl group as the functional group g. Note that it is preferable for the diamine b1 not to have a group having a dissociative proton, such as a sulfonic acid group, other than the functional group g. In one example, when the diamine b1 does not include a sulfonic acid group, it is easy to adjust the solubility of the polyimide P properly.

The diamine b1 may further have an aromatic ring. As the aromatic ring, those stated above for the tetracarboxylic dianhydride a1 can be mentioned. In the diamine b1, a substituent of the aromatic ring preferably includes the functional group g and a primary amino group. The aromatic ring may or may not have an additional substituent other than the substituent including the functional group g and the substituent including the primary amino group. The additional substituent is not particularly limited, and examples thereof include a halogen group and a hydrocarbon group. As the halogen group and the hydrocarbon group, those stated above for the tetracarboxylic dianhydride a1 can be mentioned. Note that in the diamine b1, the additional substituent may include a photopolymerizable functional group (such as a vinyl group).

The diamine b1 is preferably represented by formula (b1), formula (b2), or formula (b3) below.

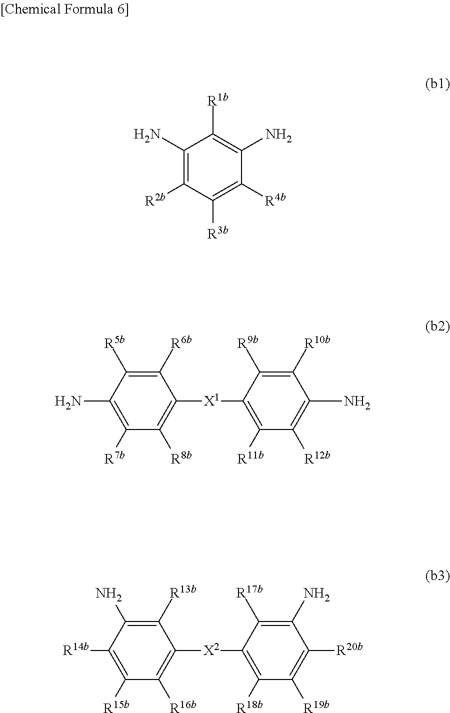

In the formula (b1), R^{1b} to R^{4b} are each independently a hydrogen atom or an optional substituent. At least one selected from the group consisting of R^{1b} to R^{4b} is a group including the functional group g, and is preferably the functional group g itself. The optional substituent other than the group including the functional group g is not particularly limited, and examples thereof include a halogen group and a hydrocarbon group. As the halogen group and the hydrocarbon group, those stated above for the tetracarboxylic dianhydride a1 can be mentioned.

In the formula (b2), R^{5b} to R^{12b} are each independently a hydrogen atom or an optional substituent, and X¹ is a single bond or an optional linking group. Note that at least one selected from the group consisting of R^{5b} to R^{12b} is a group including the functional group g, and is preferably the functional group g itself. The optional substituent other than the group including the functional group g is not particularly limited, and examples thereof include a halogen group and a hydrocarbon group. As the halogen group and the hydrocarbon group, those stated above for the tetracarboxylic dianhydride a1 can be mentioned.

In X¹ of the formula (b2), the optional linking group is a divalent hydrocarbon group, for example. Examples of the divalent hydrocarbon group include an alkylene group such as a methylene group, an ethylene group, a propane-1,3-diyl group, or a propane-2,2-diyl group. The divalent hydrocarbon group may be a halogenated hydrocarbon group in which a hydrogen atom has been substituted by a halogen group. X¹ may include a functional group, such as an ether group or an ester group, in addition to or instead of the divalent hydrocarbon group.

In the formula (b3), R^{13b} to R^{20b} are each independently a hydrogen atom or an optional substituent, and X² is a single bond or an optional linking group. Note that at least one selected from the group consisting of R^{13b} to R^{20b} is a group including the functional group g, and is preferably the functional group g itself. The optional substituent other than the group including the functional group g is not particularly limited, and examples thereof include a halogen group and a hydrocarbon group. As the halogen group and the hydrocarbon group, those stated above for the tetracarboxylic dianhydride a1 can be mentioned.

In X² of the formula (b3), the optional linking group is a divalent hydrocarbon group, for example. As the divalent hydrocarbon group, those stated above for X¹ can be mentioned. X² may include a functional group, such as an ether group or an ester group, in addition to or instead of the divalent hydrocarbon group.

In the polyimide P, the structural unit B1 derived from the diamine b1 preferably has the functional group f as described above. Particularly, the structural unit B1 preferably includes a metal salt of a carboxyl group, a metal salt of a hydroxyl group, or a metal salt of a thiol group as the functional group f, and it is particularly preferable that the structural unit B1 include the metal salt of the carboxyl group.

A metal included in the metal salt as the functional group f is not particularly limited, and examples thereof include Li, Na, K, Be, Mg, Ca, Ba, Sc, Y, Ti, Zr, V, Cr, Mo, Mn, Fe, Co, Ni, Cu, Ag, Zn, B, Al, Ga, In, and Pb. The metal is preferably Mg, Fe, Al, or Ga, and particularly preferably Al. That is, the metal salt as the functional group f is preferably an aluminum salt. Note that the metal included in the metal salt may be Na, Ca, or the like.

In the metal salt as the functional group f, the metal is specifically present as a cation. The metal (metal cation) included in the metal salt has a valence of 1 or more, for example, preferably 2 or more, and more preferably 3 or more. In one example, the metal has a valence of 2 or 3.

In the case where the structural unit B1 includes the metal salt as the functional group f, a plurality of the polyimides P can be coordinated with the metal cation included in the metal salt via a functional group such as a carboxyl group. Thereby, the polyimides P are crosslinked with each other via the metal cation. The formation of such a crosslinked structure suppresses physical aging of the polyimide P, which tends to make it possible to suppress time-dependent deterioration of the separation performance of the separation functional layer 1. In the case where the polyimide P includes the metal salt as the functional group f, the separation performance of the separation functional layer 1 tends to be improved as well. As described later, the metal salt as the functional group f can be formed by replacing, with the metal cation, a dissociative proton of the functional group g included in the polyimide obtained from a group of monomers including the tetracarboxylic dianhydride a1 and the diamine b1.

The structural unit B1 derived from the diamine b1 is preferably represented by formula (B1), formula (B2), or formula (B3) below. The structural unit B1 represented by the formula (B1) is derived from the diamine b1 represented by the above-mentioned formula (b1). The structural unit B1 represented by the formula (B2) is derived from the diamine b1 represented by the above-mentioned formula (b2). The structural unit B1 represented by the formula (B3) is derived from the diamine b1 represented by the above-mentioned formula (b3).

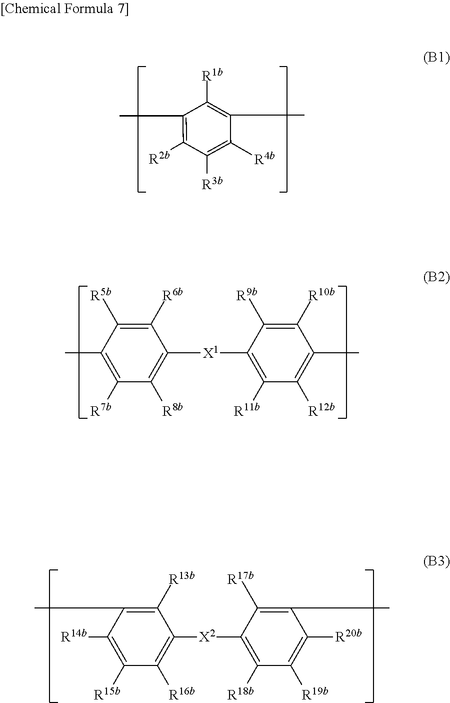

In the formula (B1), R^{1b} to R^{4b} are each independently a hydrogen atom or an optional substituent. Note that at least one selected from the group consisting of R^{1b} to R^{4b} is a group including the functional group f, and is preferably the functional group f itself. The optional substituent other than the group including the functional group f is not particularly limited, and examples thereof include a halogen group and a hydrocarbon group. As the halogen group and the hydrocarbon group, those stated above for the tetracarboxylic dianhydride a1 can be mentioned.

As specific examples of the structural unit B1 represented by the formula (B1), formulae (B1-1) to (B1-6) below can be mentioned. Note that in the formulae (B1-2), (B1-4), and (B1-6), M is an optional metal cation, preferably a Mg ion, a Fe ion, an Al ion, or a Ga ion, and particularly preferably an Al ion. M may be a Na ion or a Ca ion.

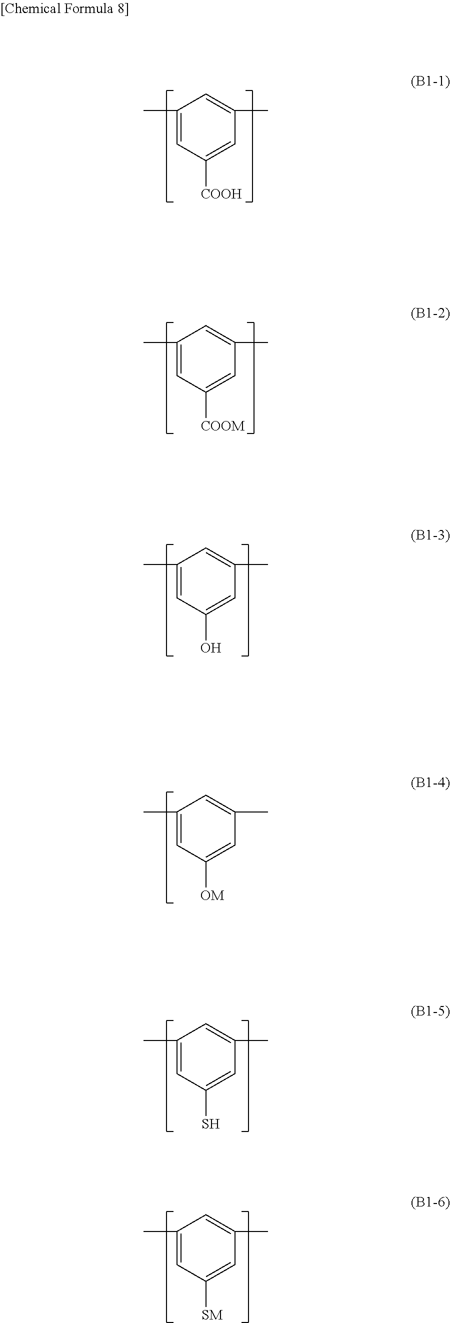

In the formula (B2), R^{5b} to R^{12b} are each independently a hydrogen atom or an optional substituent, and X¹ is a single bond or an optional linking group. Note that at least one selected from the group consisting of R^{5b} to R^{12b} is a group including the functional group f, and is preferably the functional group f itself. The optional substituent other than the group including the functional group f is not particularly limited, and examples thereof include a halogen group and a hydrocarbon group. As the halogen group and the hydrocarbon group, those stated above for the tetracarboxylic dianhydride a1 can be mentioned.

In X¹ of the formula (B2), the optional linking group is a divalent hydrocarbon group, for example. As the divalent hydrocarbon group, those stated above can be mentioned. X¹ may include a functional group, such as an ether group or an ester group, in addition to or instead of the divalent hydrocarbon group.

As specific examples of the structural unit B1 represented by the formula (B2), formulae (B2-1) to (B2-12) below can be mentioned. In these formulae, M is an optional metal cation, preferably a Mg ion, a Fe ion, an Al ion, or a Ga ion, and particularly preferably an Al ion. M may be a Na ion or a Ca ion.

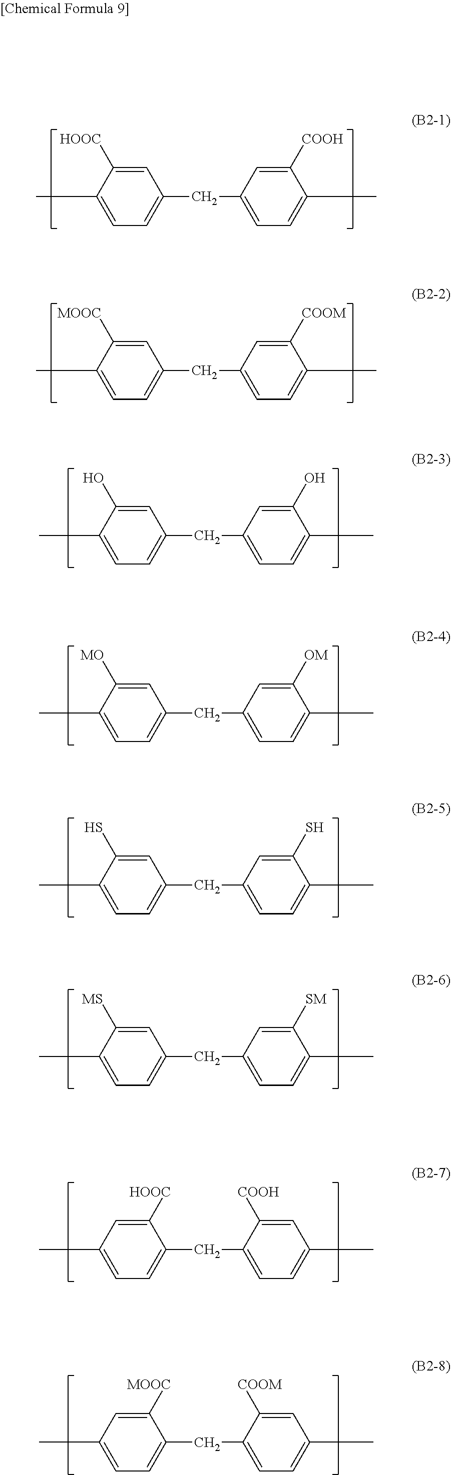

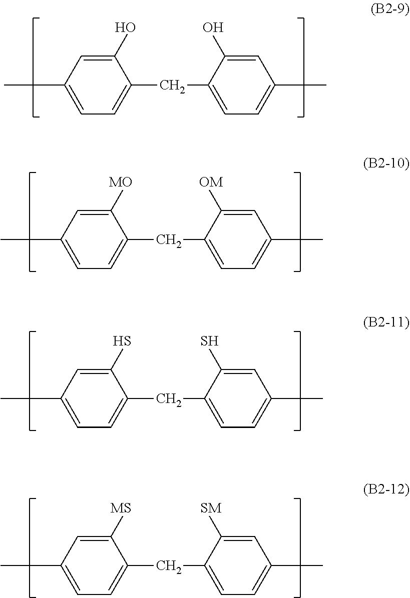

In the formula (B3), R^{13b} to R^{20b} are each independently a hydrogen atom or an optional substituent, and X² is a single bond or an optional linking group. Note that at least one selected from the group consisting of R^{13b} to R^{20b} is a group including the functional group f, and is preferably the functional group f itself. The optional substituent other than the group including the functional group f is not particularly limited, and examples thereof include a halogen group and a hydrocarbon group. As the halogen group and the hydrocarbon group, those stated above for the tetracarboxylic dianhydride a1 can be mentioned.

In X² of the formula (B3), the optional linking group is a divalent hydrocarbon group, for example. As the divalent hydrocarbon group, those stated above can be mentioned. X² may include a functional group, such as an ether group or an ester group, in addition to or instead of the divalent hydrocarbon group.

As specific examples of the structural unit B1 represented by the formula (B3), formulae (B3-1) to (B3-6) below can be mentioned. In these formulae, M is an optional metal cation, preferably a Mg ion, a Fe ion, an Al ion, or a Ga ion, and particularly preferably an Al ion. M may be a Na ion or a Ca ion.

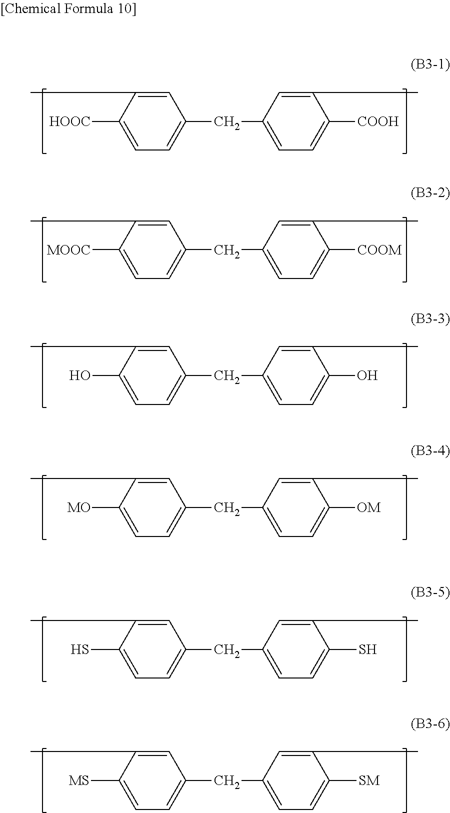

In the polyimide P, a ratio p2 of an amount of substance of the structural unit B1, particularly the structural unit B1 having the functional group f, with respect to an amount of substance of all structural units B derived from diamine is, for example, 1 mol % or more, and preferably 3 mol % or more. The upper limit of the ratio p2 is, for example, but not particularly limited to, 60 mol %, and may be 50 mol %, 40 mol %, 30 mol %, or even 25 mol %. When the ratio p2 is low, the solubility of the polyimide P tends to be improved and a desirable method for manufacturing the separation functional layer 1 tends to be adopted easily. Furthermore, the intensity of the separation functional layer 1 also tends to be improved in this case. The ratio p2 is preferably 3 to 25 mol %. When the ratio p2 is in this range, the separation functional layer 1 tends to exhibit satisfactory separation performance.

The polyimide P may further include a structural unit B2 derived from diamine b2 having a sulfonyl group (—SO₂—). The structural unit B2 is a structural unit suitable for improving the permeability and permeance of an acid gas permeating through the separation functional layer 1. The diamine b2 is a compound having two primary amino groups in addition to the sulfonyl group. The number of the sulfonyl groups in the diamine b2 is, for example, but not particularly limited to, 5 or less, and preferably 1. Preferably, the diamine b2 does not include a group having a dissociative proton, such as the above-mentioned functional group g.

The diamine b2 preferably includes a ring structure having a sulfonyl group. The ring structure having the sulfonyl group is typically a thiophene 1,1-dioxide ring ora tetrahydrothiophene 1,1-dioxide ring.

The diamine b2 may have a fused ring, and the fused ring may include the ring structure having the sulfonyl group. The fused ring may include an aromatic ring in addition to the ring structure having the sulfonyl group. As the aromatic ring, those stated above for the tetracarboxylic dianhydride a1 can be mentioned.

In the diamine b2, a substituent of the fused ring preferably includes a primary amino group. The fused ring may or may not have an additional substituent other than the substituent including the primary amino group. The additional substituent is not particularly limited, and examples thereof include a halogen group and a hydrocarbon group. As the halogen group and the hydrocarbon group, those stated above for the tetracarboxylic dianhydride a1 can be mentioned.

The diamine b2 is preferably represented by formula (c1) below.

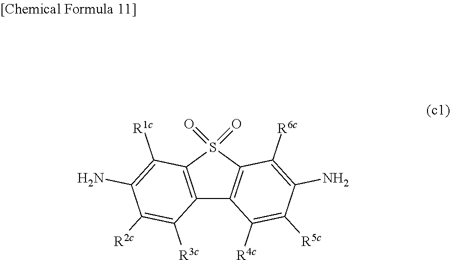

In the formula (c1), R^{1c} to R^{6c} are each independently a hydrogen atom or an optional substituent. In the formula (c1), the optional substituent is, for example, a substituent other than a group including the above-mentioned functional group g, and is specifically a halogen group, a hydrocarbon group, or the like. As the halogen group and the hydrocarbon group, those stated above for the tetracarboxylic dianhydride a1 can be mentioned.

In the polyimide P, the structural unit B2 derived from the diamine b2 is preferably represented by formula (C1) below. The structural unit B2 represented by the formula (C1) is derived from the diamine b2 represented by the above-mentioned formula (c1).

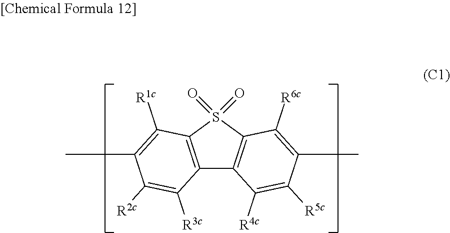

In the formula (C1), R^{1c} to R^{6c} are each independently a hydrogen atom or an optional substituent. In the formula (C1), the optional substituent is, for example, a substituent other than a group including the above-mentioned functional group f, and is specifically a halogen group, a hydrocarbon group, or the like. As the halogen group and the hydrocarbon group, those stated above for the tetracarboxylic dianhydride a1 can be mentioned. The structural unit B2 represented by the formula (C1) is suitable for improving the stiffness of the polyimide P. The polyimide P with excellent stiffness tends to be able to suppress plasticization of the separation functional layer 1 even when the gas mixture to be separated has a high pressure.

As specific examples of the structural unit B2 represented by the formula (C1), formulae (C1-1) and (C1-2) below can be mentioned.

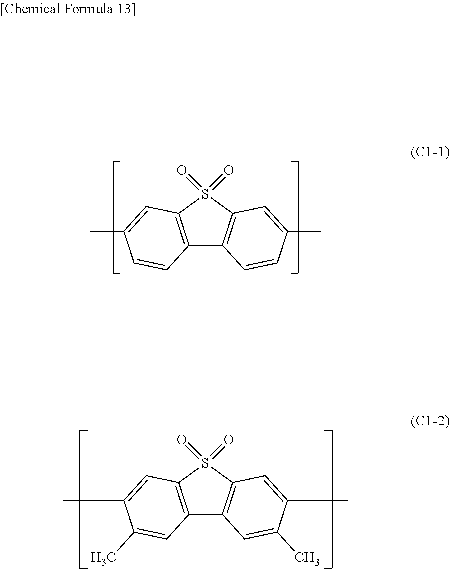

In the polyimide P, a ratio p3 of an amount of substance of the above-mentioned structural unit B2 with respect to the amount of substance of all structural units B derived from diamine is, for example, but not particularly limited to, 5 mol % or more, and may be 10 mol % or more, 20 mol % or more, 30 mol % or more, or even 40 mol % or more. The upper limit of the ratio p3 is, for example, but not particularly limited to, 95 mol %, and may be 90 mol %, 80 mol %, 70 mol %, 60 mol %, or even 50 mol %.

The polyimide P may further include a structural unit B3 derived from diamine b3, which is additional diamine, other than the diamines b1 and b2. The diamine b3 is a compound that does not have the above-mentioned functional group g or sulfonyl group but has two primary amino groups. Preferably, the diamine b3 does not include a group having a dissociative proton.

The diamine b3 may further have an aromatic ring. As the aromatic ring, those stated above for the tetracarboxylic dianhydride a1 can be mentioned. In the diamine b3, a substituent of the aromatic ring preferably includes a primary amino group. The aromatic ring may or may not have an additional substituent other than the substituent including the primary amino group. The additional substituent is not particularly limited, and examples thereof include a halogen group and a hydrocarbon group. As the halogen group and the hydrocarbon group, those stated above for the tetracarboxylic dianhydride a1 can be mentioned.

The diamine b3 is preferably represented by formula (d1), formula (d2), or formula (d3) below.

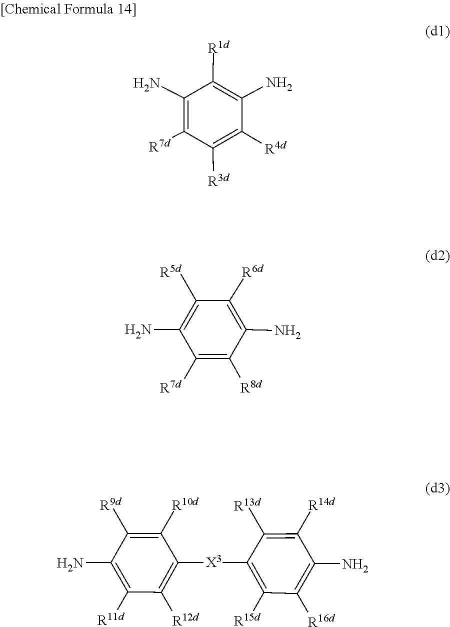

In the formula (d1), R^{1d} to R^{4d} are each independently a hydrogen atom or an optional substituent. In the formula (d1), the optional substituent is, for example, a substituent other than a group including the above-mentioned functional group g and a group including a sulfonyl group, and is specifically a halogen group, a hydrocarbon group, or the like. As the halogen group and the hydrocarbon group, those stated above for the tetracarboxylic dianhydride a1 can be mentioned.

In the formula (d2), R^{5d} to R^{8d} are each independently a hydrogen atom or an optional substituent. In the formula (d2), the optional substituent is, for example, a substituent other than a group including the above-mentioned functional group g and a group including a sulfonyl group, and is specifically a halogen group, a hydrocarbon group, or the like. As the halogen group and the hydrocarbon group, those stated above for the tetracarboxylic dianhydride a1 can be mentioned.

In the formula (d3), R^{9d} to R^{16d} are each independently a hydrogen atom or an optional substituent, and X³ is a single bond or an optional linking group. In the formula (d3), the optional substituent is, for example, a substituent other than a group including the above-mentioned functional group g and a group including a sulfonyl group, and is specifically a halogen group, a hydrocarbon group, or the like. As the halogen group and the hydrocarbon group, those stated above for the tetracarboxylic dianhydride a1 can be mentioned.

In X³ of the formula (d3), the optional linking group is a divalent hydrocarbon group, for example. As the divalent hydrocarbon group, those stated above can be mentioned. In X³, the divalent hydrocarbon group may further have an aromatic ring. As the aromatic ring, those stated above for the tetracarboxylic dianhydride a1 can be mentioned. The divalent hydrocarbon group in X³ may be a fluorenediyl group. X³ may include a functional group, such as an ether group or an ester group, in addition to or instead of the divalent hydrocarbon group.

The structural unit B3 derived from the diamine b3 is preferably presented by formula (D1), formula (D2), or formula (D3) below. The structural unit B3 represented by the formula (D1) is derived from the diamine b3 represented by the above-mentioned formula (d1). The structural unit B3 represented by the formula (D2) is derived from the diamine b3 represented by the above-mentioned formula (d2). The structural unit B3 represented by the formula (D3) is derived from the diamine b3 represented by the above-mentioned formula (d3).

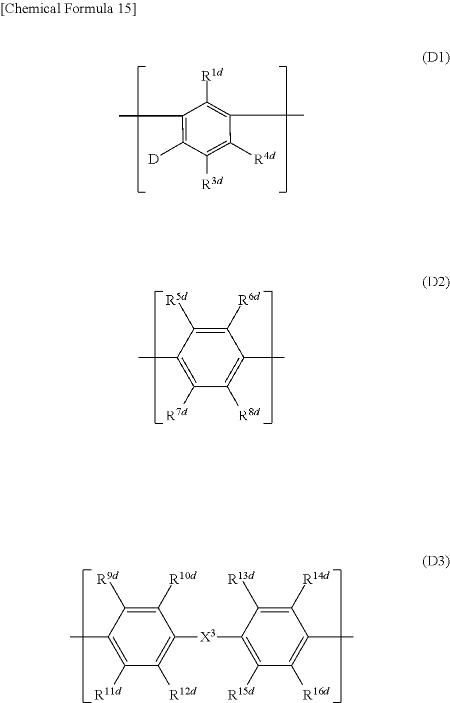

In the formula (D1), R^{1d} to R^{4d} are each independently a hydrogen atom or an optional substituent. In the formula (D1), the optional substituent is, for example, a substituent other than a group including the above-mentioned functional group f, and is specifically a halogen group, a hydrocarbon group, or the like. As the halogen group and the hydrocarbon group, those stated above for the tetracarboxylic dianhydride a1 can be mentioned. As a specific example of the structural unit B3 represented by the formula (D1), formula (D1-1) below can be mentioned.

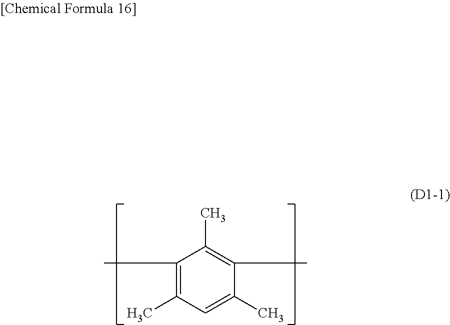

In the formula (D2), R^{5d} to R^{8d} are each independently a hydrogen atom or an optional substituent. In the formula (D2), the optional substituent is, for example, a substituent other than a group including the above-mentioned functional group f, and is specifically a halogen group, a hydrocarbon group, or the like. As the halogen group and the hydrocarbon group, those stated above for the tetracarboxylic dianhydride a1 can be mentioned. As a specific example of the structural unit B3 represented by the formula (D2), formula (D2-1) below can be mentioned.

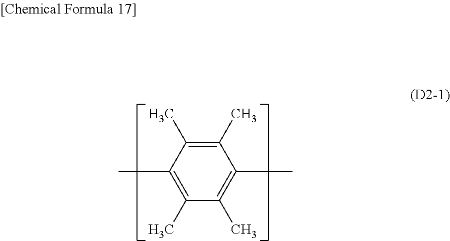

In the formula (D3), R^{9d} to R^{16d} are each independently a hydrogen atom or an optional substituent, and X³ is a single bond or an optional linking group. In the formula (D3), the optional substituent is, for example, a substituent other than a group including the above-mentioned functional group f, and is specifically a halogen group, a hydrocarbon group, or the like. As the halogen group and the hydrocarbon group, those stated above for the tetracarboxylic dianhydride a1 can be mentioned. In X³ of the formula (D3), the optional linking group is a divalent hydrocarbon group, for example. As the divalent hydrocarbon group, those stated above can be mentioned. X³ may include a functional group, such as an ether group or an ester group, in addition to or instead of the divalent hydrocarbon group. As specific examples of the structural unit B3 represented by the formula (D3), formulae (D3-1) to (D3-3) below can be mentioned.

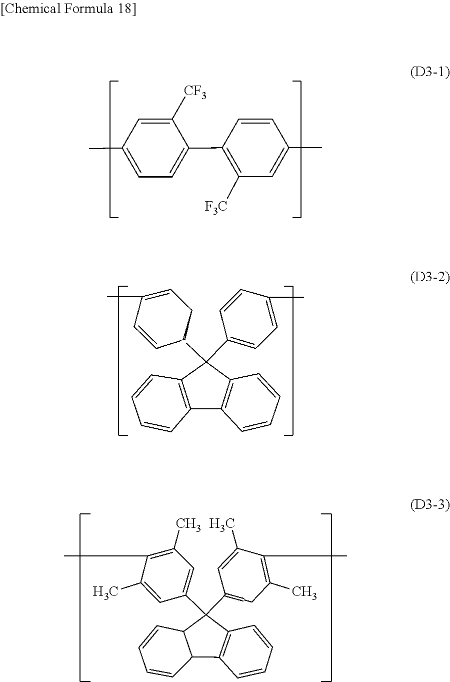

In the polyimide P, a ratio p4 of an amount of substance of the above-mentioned structural unit B3 with respect to the amount of substance of all structural units B derived from diamine is, for example, but not particularly limited to, 5 mol % or more, and may be 10 mol % or more, 20 mol % or more, 30 mol % or more, or even 40 mol % or more. The upper limit of the ratio p4 is, for example, but not particularly limited to, 95 mol %, and may be 90 mol %, 80 mol %, 70 mol %, 60 mol %, or even 50 mol %.

In the polyimide P, the structural units A derived from the tetracarboxylic dianhydride and the structural units B derived from the diamine are arranged alternately. In the polyimide P, examples of the combination of the structural units A and B adjacent to each other include formula (A1-B1), formula (A1-B2), formula (A1-C1), and formula (A1-D1) below. Note that in these formulae, R^{1a} to R^{4a}, R^{1b} to R^{12b}, R^{1c} to R^{6c}, and R^{1d} to R^{4d} are the same as those described above for the formula (A1), the formula (B1), the formula (B2), the formula (C1), and the formula (D1).

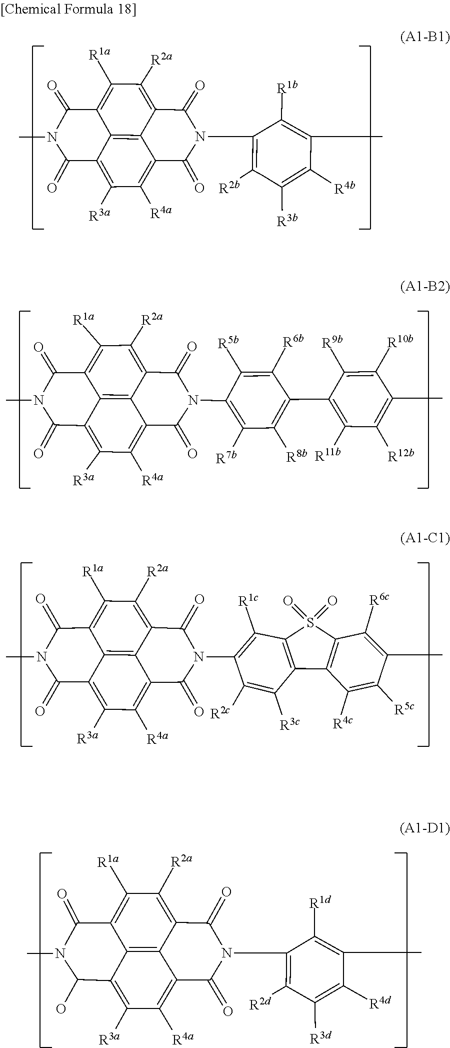

From the viewpoint of mechanical strength of the separation functional layer 1, the polyimide P has a weight-average molecular weight (Mw) of 30000 or more, for example, and preferably 50000 or more, and still more preferably 75000 or more. The upper limit of the weight-average molecular weight of the polyimide P is, for example, but not particularly limited to, 1000000. A molecular weight distribution of the polyimide P is measured by gel permeation chromatograph (GPC) including a differential refractive index detector (RID) so that the weight-average molecular weight of the polyimide P can be calculated from the obtained chromatogram (chart) using a calibration curve of standard polystyrene.

The content of the polyimide P in the separation functional layer 1 is, for example, 50 wt % or more, and may be 60 wt % or more, 70 wt % or more, 80 wt % or more, 90 wt % or more, or even 95 wt % or more. The separation functional layer 1 may be composed substantially of the polyimide P alone.

The separation functional layer 1 may further include an additional component other than the polyimide P. Examples of the additional component include a filler. As the filler, those stated as examples for the later-described intermediate layer 2 can be mentioned, for example. In the separation functional layer 1, the filler is preferably dispersed in a matrix including the polyimide P. Particles of the filler may be spaced from each other in the matrix, or may aggregate partially.

The thickness of the separation functional layer 1 is, for example, 10 μm or less, and may be 8.0 μm or less, 5.0 μm or less, 4.0 μm or less, 3.0 μm or less, or even 2.0 μm or less. The thickness of the separation functional layer 1 may be 0.05 μm or more, or 0.1 μm or more.

### (Intermediate Layer)

The intermediate layer 2 is preferably formed from a pressure-sensitive adhesive composition, particularly a pressure-sensitive adhesive composition including a silicone-based polymer. The silicone-based polymer refers to a polymer having a structural unit including a siloxane bond. In the present description, the pressure-sensitive adhesive composition including the silicone-based polymer is sometimes referred to as a “silicone-based pressure-sensitive adhesive.”

Examples of the silicone-based pressure-sensitive adhesive include a peroxide crosslinking-type silicone-based pressure-sensitive adhesive, an addition reaction-type silicone-based pressure-sensitive adhesive, and an active energy ray-curable silicone-based pressure-sensitive adhesive. The peroxide crosslinking-type silicone-based pressure-sensitive adhesive includes an organic peroxide (such as benzoyl peroxide). This organic peroxide causes radical crosslinking. Examples of the addition reaction-type silicone-based pressure-sensitive adhesive include a hydrosilylation-type silicone-based pressure-sensitive adhesive. The hydrosilylation-type silicone-based pressure-sensitive adhesive includes a SiH group-containing siloxane crosslinking agent and a platinum-based catalyst. A hydrosilylation reaction using this platinum-based catalyst causes crosslinking. A crosslinking reaction of the active energy ray-curable silicone-based pressure-sensitive adhesive proceeds with light such as an ultraviolet ray or an electron ray. Particularly, the addition reaction-type silicone-based pressure-sensitive adhesive, such as the hydrosilylation-type silicone-based pressure-sensitive adhesive, is preferable from the viewpoints of unlikeliness to leave a residue on the intermediate layer 2, capability to react at a low temperature, and reaction rate.

The silicone-based pressure-sensitive adhesive preferably includes a silicone resin component and a silicone gum component as the silicone-based polymer from the viewpoint of easiness to control adhesiveness, peelability, and aggregability.

The silicone resin component is not particularly limited and is preferably branched polyorganosiloxane including, in a molecule thereof, a hydroxyl group bonded to a silicon atom, and more preferably polyorganosiloxane having at least one unit selected from the group consisting of an M unit (R₃SiO_{1/2}), a Q unit (SiO₂), a T unit (RSiO_{3/2}), and a D unit (R₂SiO). In the above-mentioned units, each R is independently a monovalent hydrocarbon group or hydroxyl group. As the monovalent hydrocarbon group, there can be mentioned an alkyl group (such as a methyl group, an ethyl group, or a propyl group), an alkenyl group (such as a vinyl group), and an aryl group (such as a phenyl group). Particularly, the silicone resin component is preferably an MQ resin composed of an M unit (R₃SiO_{1/2}) and a Q unit (SiO₂). One of these silicone resin components may be used alone or two or more of them may be used in combination.

The silicone gum component is not particularly limited and is preferably linear polyorganosiloxane represented by formula (2) below.

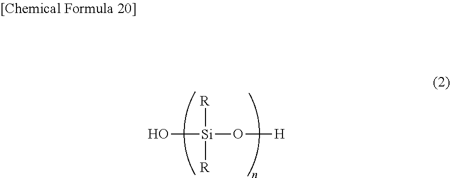

In the formula (2), each R is independently a methyl group, a phenyl group, or an alkenyl group. The symbol n is a number from 100 to 10000. One of these silicone gum components may be used alone or two or more of them may be used in combination.

In the peroxide crosslinking-type silicone-based pressure-sensitive adhesive, the above-mentioned silicone gum component preferably includes a methyl group. In the peroxide crosslinking-type silicone-based pressure-sensitive adhesive, the methyl group of the silicone gum component is radically crosslinked. In the hydrosilylation-type silicone-based pressure-sensitive adhesive, the above-mentioned silicone gum component preferably includes an alkenyl group, particularly a vinyl group. In the hydrosilylation-type silicone-based pressure-sensitive adhesive, the alkenyl group of the silicone gum component is crosslinked through a hydrosilylation reaction.

The pressure-sensitive adhesive composition (silicone-based pressure-sensitive adhesive) may include an additive other than the silicone resin component and the silicone gum component. Examples of the additive include a material for allowing a crosslinking reaction to proceed (such as an organic peroxide, a SiH group-containing siloxane crosslinking agent, or a platinum-based catalyst), an adhesion improver (such as X-92-185 available from Shin-Etsu Chemical Co., Ltd.), a silane coupling agent, a filling material, a plasticizer, an age resistor, an antistatic agent, a colorant (a pigment, a dye), and the later-described filler. One of these additives may be used alone or two or more of them can be used in combination.

The pressure-sensitive adhesive composition (silicone-based pressure-sensitive adhesive) may further include an organic solvent (such as toluene or xylene).

Specific examples of the pressure-sensitive adhesive composition (silicone-based pressure-sensitive adhesive) include “KR-3700”, “KR-3701”, and “KR-3704” available from Shin-Etsu Chemical Co., Ltd. These commercially available products are each provided as a type of product including both the silicone gum component and the silicone resin component. The silicone-based pressure-sensitive adhesive may include a mixture of these products.

As described above, the intermediate layer 2 is preferably formed from the pressure-sensitive adhesive composition, particularly the pressure-sensitive adhesive composition (silicone-based pressure-sensitive adhesive) including the silicone-based polymer. The intermediate layer 2 formed from the silicone-based pressure-sensitive adhesive preferably includes a crosslinked product of the silicone-based polymer. The content of the crosslinked product of the silicone-based polymer in the intermediate layer 2 is, for example, but not particularly limited to, 60 wt % or more, preferably 70 wt % or more, and more preferably 90 wt % or more. The intermediate layer 2 may be composed substantially of the crosslinked product of the silicone-based polymer.

The intermediate layer 2 may further include the above-mentioned additive, particularly a filler. The intermediate layer 2 including a filler is suitable for improving the permeance of an acid gas permeating through the separation membrane 10. The filler may include an inorganic material. The filler may include an organic material. Examples of the inorganic material included in the filler include zeolite, silica, titania, and alumina. Examples of the organic material include a (meth)acrylic polymer. In the present description, the “(meth)acrylic polymer” refers to an acrylic polymer and/or a methacrylic polymer.

The filler may include a metal organic framework (MOF). The metal organic framework is also referred to as a porous coordination polymer (PCP). The metal organic framework preferably includes a metal ion and an organic ligand. Examples of the metal ion include a Cu ion and a Zn ion. The organic ligand preferably includes an aromatic ring. Examples of the aromatic ring included in the organic ligand include a benzene ring and an imidazole ring. Examples of the organic ligand include trimesic acid and 2-methylimidazole. Specific examples of the metal organic framework include HKUST-1 and ZIF-8.

The filler typically has a particulate shape. In the present description, the “particulate shape” is a shape such as a spherical shape, an elliptical shape, a flaky shape, or a fibrous shape.

An average particle diameter of the filler is, for example, but not particularly limited to, 5 μm or less, and may be 1 μm or less, 800 nm or less, 600 nm or less, 500 nm or less, 400 nm or less, 300 nm or less, 200 nm or less, or even 100 nm or less. The lower limit of the average particle diameter of the filler is 1 nm, for example. The average particle diameter of the filler can be determined by the following method. First, a cross section of the intermediate layer 2 is observed with a transmission electron microscope. The area of a specific particle of the filler on the resulting electron microscope image is calculated by image processing. The diameter of a circle having the same area as the calculated area is regarded as the particle diameter (the diameter of the particle) of the specific filler particle. The particle diameter is calculated for any number (at least 50) of the filler particles, and the average of the calculated values is regarded as the average particle diameter of the filler.

The content of the filler in the intermediate layer 2 is, for example, 40 wt % or less, and may be 30 wt % or less, 20 wt % or less, or even 10 wt % or less from the viewpoint of suppressing an increase in the storage elastic modulus of the intermediate layer 2. The lower limit of the content of the filler in the intermediate layer 2 is not particularly limited and is, for example, 1 wt % from the viewpoint of improving the permeance of the acid gas.

The intermediate layer 2 formed from the pressure-sensitive adhesive composition tends to have a low storage elastic modulus. In one example, the storage elastic modulus of the intermediate layer 2 at 25° C. is, for example, 1.0×10⁵ Pa or less, preferably 0.95×10⁵ Pa or less, and may be 0.90×10⁵ Pa or less or 0.85×10⁵ Pa or less. The lower the storage elastic modulus of the intermediate layer 2 is, the higher the adhesive strength between the intermediate layer 2 and the porous support member 3 tends to be. The storage elastic modulus of the intermediate layer 2 at 25° C. is preferably 0.1×10⁵ Pa or more.

The storage elastic modulus of the intermediate layer 2 at 25° C. can be determined by the following method. First, a measurement sample made from the materials that the intermediate layer 2 is composed of is prepared. The measurement sample has a disk-like shape. The measurement sample is 2 mm in thickness, and has a bottom surface with a diameter of 8 mm. The measurement sample may be obtained by preparing a plurality of the intermediate layers 2 and punching a disk-like piece out of a laminate obtained by stacking the intermediate layers 2. Next, the measurement sample is subjected to a dynamic viscoelasticity measurement. For the dynamic viscoelasticity measurement, “Advanced Rheometric Expansion System (ARES)” available from Rheometric Scientific can be used. From the result of the dynamic viscoelasticity measurement, the storage elastic modulus of the intermediate layer 2 at 25° C. can be determined. Conditions of the dynamic viscoelasticity measurement are as follows.

### Measurement Conditions

Frequency: 1 Hz
Deformation mode: Torsion
Measurement temperature: −70° C. to 150° C.
Heating rate: 5° C./minute

The thickness of the intermediate layer 2 is, for example, 10 μm or less, and may be 8.0 μm or less, 5.0 μm or less, 4.0 μm or less, 3.0 μm or less, or even 2.0 μm or less. The thickness of the intermediate layer 2 may be 0.05 μm or more, 0.1 μm or more, or even 0.5 μm or more.

### (Porous Support Member)

In the present embodiment, the porous support member 3 preferably has a body portion only and does not have a microporous layer made from a polymer or the like. The porous support member 3 may be composed only of a single material. The porous support member 3 is preferably a fiber structure, such as a woven fabric, a nonwoven fabric, a net, or a mesh, and typically is a nonwoven fabric. Example of fiber included in the fiber structure include: natural fiber such as wood pulp, cotton, or hemp (such as Manila hemp); and chemical fiber (synthetic fiber) such as polyester fiber, polyphenylene sulfide (PPS) fiber, rayon, vinylon, acetate fiber, polyvinyl alcohol (PVA) fiber, polyamide fiber, polyolefin fiber, or polyurethane fiber. As the porous support member 3, preferred are a nonwoven fabric composed of polyester fiber such as polyethylene terephthalate (PET) fiber, and a nonwoven fabric composed of PPS fiber. In the present embodiment, the intermediate layer 2 is preferably in direct contact with the fiber structure (specifically the nonwoven fabric).

In another aspect, the present invention provides the separation membrane 10 including:
the separation functional layer 1;
the porous support member 3 supporting the separation functional layer 1; and
the intermediate layer 2 that is disposed between the separation functional layer 1 and the porous support member 3 and that is in direct contact with the porous support member 3, wherein
the porous support member 3 is the fiber structure.

As described above, in the present embodiment, the porous support member 3 has no microporous layer, for example, and tends to have a small thickness. The thickness of the porous support member 3 is, for example, 200 μm or less, and may be 150 μm or less, 125 μm or less, 110 μm or less, 100 μm or less, 80 μm or less, or even 60 μm or less. The lower limit of the thickness of the porous support member 3 is, for example, 10 μm or more, and may be 30 μm or more, or even 50 μm or more.

In the present embodiment, the load area ratio Smr(c₁) of the surface S1 of the porous support member 3 is low, and thus the porous support member 3 tends to have a high gas permeability by itself. In one example, an ISO air permeability of the porous support member 3 is, for example, 5.0×10⁴ μm/(Pa·s) or more, and may be 10.0×10⁴ μm/(Pa·s) or more, 20.0×10⁴ μm/(Pa·s) or more, 30.0×10⁴ μm/(Pa·s) or more, 40.0×10⁴ μm/(Pa·s) or more, 50.0×10⁴ μm/(Pa·s) or more, 70.0×10⁴ μm/(Pa·s) or more, or even 100.0×10⁴ μm/(Pa·s) or more. The upper limit of the ISO air permeability of the porous support member 3 is, for example, but not particularly limited to, 1000.0×10⁴ μm/(Pa·s) or less. The ISO air permeability of the porous support member 3 can be measured in accordance with an Oken-type tester method prescribed in JIS P8117:2009.

In the present embodiment, the intermediate layer 2 and the porous support member 3 are preferably bonded to each other with a sufficient strength. In one example, the peel strength between the intermediate layer 2 and the porous support member 3 is, for example, 0.25 N/25 mm or more, and may be 0.50 N/25 mm or more, 0.75 N/25 mm or more, 1.00 N/25 mm or more, 1.25 N/25 mm or more, 1.50 N/25 mm or more, 1.75 N/25 mm or more, or even 2.00 N/25 mm or more. The upper limit of the peel strength is, for example, but not particularly limited to, 10.0 N/25 mm or less.

The peel strength between the intermediate layer 2 and the porous support member 3 can be measured by the following method. First, the intermediate layer 2 is formed on an evaluation sheet (DIAFOIL T100-50 available from Mitsubishi Plastics Industries, Ltd., thickness: 50 μm). The intermediate layer 2 can be produced by the later-described method. Next, a surface of the intermediate layer 2 is entirely laid on the porous support member 3, and a 2 kg roller is rolled thereon back and forth once so that they are press-bonded. Thereby, a laminate having the evaluation sheet, the intermediate layer 2, and the porous support member 3 in this order is formed. The laminate is cut into a piece that is 25 mm in width and 100 mm in length to obtain a specimen. Next, a surface of the porous support member 3 included in the specimen is entirely laid on a polyethylene terephthalate film via a double-sided adhesive tape (No. 500 available from Nitto Denko Corporation), and a 2 kg roller is rolled thereon back and forth once so that they are press-bonded. Next, the porous support member 3 is peeled off, together with the film, from the intermediate layer 2 at a peel angle of 180° and a peel rate of 100 mm/min by using a commercially available tensile testing machine. The peel force at that time can be considered as the peel strength between the intermediate layer 2 and the porous support member 3. The above-mentioned measurement is made under a 23° C. atmosphere.

### (Method for Producing Separation Membrane)

The separation membrane 10 of the present embodiment can be produced by the following method. First, the separation functional layer 1 is formed by applying a coating liquid containing the materials of the separation functional layer 1 onto a substrate and drying the coating liquid.

In a preferred embodiment, the coating liquid contains polyimide Q having at least one functional group g selected from the group consisting of a carboxyl group, a hydroxyl group, and a thiol group, and a compound M having a metal. In this embodiment, the polyimide Q is the precursor of the polyimide P, and a dissociative proton of the functional group g is replaced with a metal cation and thereby the polyimide P can be formed from the polyimide Q. As described later, this coating liquid makes it possible to form the polyimide P having a metal salt as the above-mentioned functional group f.

The polyimide Q can be produced by the following method. First, a group of diamines including the above-mentioned diamine b1 is dissolved in a solvent to obtain a solution. Examples of the solvent include a polar organic solvent such as N-methyl-2-pyrrolidone or 1,3-dioxolane.

Next, a group of tetracarboxylic dianhydrides including the above-mentioned tetracarboxylic dianhydride a1 are added gradually to the obtained solution. This makes a group of monomers including the tetracarboxylic dianhydride a1 and the diamine b1 react with each other to form polyamide acid. The addition of the group of tetracarboxylic dianhydrides is preferably carried out for 3 to 20 hours in a heating environment at 140° C. or higher under the condition that the solution is being stirred.

Subsequently, the polyamide acid is imidized to obtain the polyimide Q. Examples of the imidization method include a chemical imidization method and a thermal imidization method. The chemical imidization method is a method for imidizing polyamide acid using a dehydration condensation agent under, for example, a room temperature condition. Examples of the dehydration condensation agent include acetic anhydride, pyridine, and triethylamine. The thermal imidization method is a method for imidizing polyamide acid by a heat treatment. The heat treatment is carried out at a temperature of 180° C. or higher, for example.

The content of the polyimide Q in the coating liquid can be adjusted suitably in accordance with the solubility of the polyimide Q, and it is 1 wt % to 30 wt %, for example. In the coating liquid, the ratio of the weight of the polyimide Q with respect to the total weight of the polyimide Q and a solvent is 1 wt % to 30 wt %, for example.

As the metal that the compound M has, those stated above as the metal included in the metal salt as the functional group f can be mentioned. In the compound M, the metal is preferably present as a cation. Examples of the compound M include a metal complex having the metal and a ligand coordinated with the metal, and an inorganic salt including the metal. The compound M preferably includes the metal complex.

In the metal complex, the ligand preferably has volatility. In one example, the ligand may have a boiling point of 20° C. to 260° C. under an atmospheric pressure (101.325 kPa). The ligand having volatility is likely to evaporate at the time of drying the coating film described later, and is unlikely to remain in the separation functional layer 1. Note that the ligand does not need to have volatility. In this case, it is possible to remove the ligand from the separation functional layer 1 easily by performing a washing operation after the formation of the separation functional layer 1.

In the metal complex, the ligand is typically an organic ligand having a functional group for coordination with a metal. The number of carbon atoms in the organic ligand is, for example, but not particularly limited to, 1 to 10. Examples of the functional group included in the organic ligand include a carbonyl group such as a ketone group. The number of the functional groups included in the organic ligand is, for example, 1 or more, and may be 2 or more. Specific examples of the organic ligand include acetylacetonato (acac). Specific examples of the metal complex include Al(acac)₃, Fe(acac)₂, Ga(acac)₃, and Mg(acac)₂.

Examples of the inorganic salt include a chloride, a nitrate, and a sulfate, and specific examples thereof include LiCl, NaCl, KCl, AgNO₃, MgCl₂, CaCl₂, BaCl₂, NiCl₂, ZnCl₂, CuCl₂, Pb(NO₃)₂, Al(NO₃)₃, Fe₂(SO₄)₃, Ga(NO₃)₃, Fe(NO₃)₂, and Mg(NO₃)₂.

In the coating liquid, the ratio of the weight of the compound M with respect to the weight of the polyimide Q can be adjusted suitably in accordance with the composition of the polyimide Q, etc., and it is, for example, 1 to 20 wt %, and may be 1 to 10 wt %. In the coating liquid, the ratio of an amount of substance of the compound M with respect to an amount of substance of the functional group g included in the polyimide Q is, for example, but not particularly limited to, 2.0 or more.

In the case where the coating liquid contains the metal complex as the compound M, the coating liquid may further contain a ligand. In the coating liquid, the ratio of the weight of the ligand with respect to the weight of the polyimide Q can be adjusted suitably in accordance with the contents of the polyimide Q and the metal complex, etc., and it is, for example, 1 to 20 wt %, and may be 1 to 10 wt %.

Preferably, the coating liquid further includes a solvent. The solvent is typically a good solvent that can dissolve the polyimide Q. The solvent preferably includes at least one selected from the group consisting of an amide compound and a lactone compound, and more preferably includes an amide compound. Examples of the amide compound include N,N-dimethylformamide (DMF), N-methyl-2-pyrrolidone (NMP), and N,N-dimethylacetamide (DMAc). Examples of the lactone compound include γ-butyrolactone.

The content of the solvent in the coating liquid is 30 wt % to 95 wt %, for example. In the coating liquid, the ratio of the weight of the solvent with respect to the total weight of the polyimide Q and the solvent is 30 wt % to 95 wt %, for example.

The coating liquid is not limited to those having the above-mentioned composition. In another preferred embodiment, the coating liquid contains the polyimide P instead of the polyimide Q and the compound M mentioned above. In this embodiment, the polyimide P preferably has at least one functional group f selected from the group consisting of a carboxyl group, a hydroxyl group, a thiol group, and metal salts of these groups.

Typically, the substrate is a release liner. Examples of the substrate include: a film including a resin; paper; and a sheet including a metal material such as aluminum or stainless steel. The sheet including a metal material tends to have high heat resistance. The substrate is preferably a film including a resin from the viewpoint of having excellent surface smoothness. Examples of a polymer included in the resin in the substrate include: polyolefin such as polyethylene, polypropylene, polybutene, polybutadiene, or polymethylpentene; polyester such as polyethylene terephthalate, polybutylene terephthalate, or polyethylene naphthalate; polyvinyl chloride and a vinyl chloride copolymer; polyurethane; an ethylene-vinyl acetate copolymer; and polyimide, and preferred is polyimide.

A surface of the substrate may be subjected to a release treatment. The release treatment can be provided by applying a release treatment agent onto the surface of the substrate. Examples of the release treatment agent include a silicone-based release treatment agent, a long-chain alkyl-based release treatment agent, a fluorine-based release treatment agent, and a molybdenum sulfide-based release treatment agent. One of these release treatment agents may be used alone or two or more of them can be used in combination. The substrate is preferably a polyimide film subjected to the release treatment.

The thickness of the substrate is, for example, but not particularly limited to, 5 to 100 μm, and preferably 10 to 50 μm.

The substrate may be subjected to a surface modification treatment before the coating liquid is applied thereonto. In the case where the substrate is subjected to the release treatment, the surface modification treatment may be provided to the surface of the substrate, the surface having been subjected to the release treatment. Examples of the surface modification treatment include a corona treatment, a plasma treatment, an excimer treatment, and a frame treatment, and preferred is a corona treatment.

The surface modification treatment can be performed by irradiating the surface of the substrate with an active energy ray. Specific examples of the active energy ray include an electron ray, an ion beam, a plasma beam, and an ultraviolet ray. In the case where the corona treatment is performed as the surface modification treatment, the discharge amount is 0.1 kW·min/m² or more, for example. The upper limit of the discharge amount is, for example, but not particularly limited to, 10 kW·min/m².

The method for applying the coating liquid onto the substrate is not particularly limited, and a spin coating method, a dip coating method, and a slot-die coating method can be used, for example. The coating liquid may be applied onto the substrate using an applicator, a wire bar, or the like. The coating liquid may be applied onto the surface of the substrate, the surface having been subjected to the release treatment and/or the surface modification treatment.

A coating film is formed by applying the coating liquid onto the substrate. The thickness of the coating film can be adjusted suitably in accordance with a target thickness of the separation functional layer 1, and it is 1 μm to 100 μm, for example.

In the present embodiment, the separation functional layer 1 can be obtained by drying the coating film. The conditions for drying the coating film are not particularly limited, and they are, for example, that the drying temperature is 50° C. to 200° C. and the drying time is 1 minute to 10 hours. The coating film can be dried using a heater or the like. In one example, the coating film may be dried by passing through a heating unit including a heater. The coating film may be dried by passing through a plurality of heating units. The set temperatures of the heating units may be equal to or different from each other.

In the case where the coating liquid contains the polyimide Q having the functional group g and the compound M having the metal, a dissociative proton included in the functional group g of the polyimide Q is replaced with the metal (metal cation) of the compound M at the time of drying the coating film. Especially, in the case where the compound M is a metal complex and a ligand included in the metal complex is volatile, the ligand is evaporated at the time of the drying and thereby the replacement of the dissociative proton of the functional group g with the metal of the compound M tends to be accelerated. Because of the replacement of the dissociative proton of the functional group g with the metal of the compound M, a metal salt of the functional group g is formed and the polyimide P is formed from the polyimide Q. In the separation functional layer 1 obtained by this method, a plurality of molecules of the polyimide P are usually crosslinked with each other via the metal cation. By having this crosslinked structure, the separation functional layer 1 tends to have high solvent resistance.

The replacement of the dissociative proton included in the functional group g with the metal of the compound M may be made after the formation of the separation functional layer 1. For example, the coating liquid containing the polyimide Q and the solvent mentioned above is applied onto the substrate and dried to form the separation functional layer 1. By immersing the separation functional layer 1 in a solution containing the compound M mentioned above, the dissociative proton of the functional group g may be replaced with the metal of the compound M. The solution containing the compound M is preferably an aqueous solution containing the above-mentioned inorganic salt. The concentration of the inorganic salt in the aqueous solution is, for example, but not particularly limited to, 0.01 to 1 mol/L. The conditions for the operation of immersing the separation functional layer 1 in the solution containing the compound M are not particularly limited, and the operation may be performed under a room temperature condition for 1 to 48 hours. The separation functional layer 1 after being immersed in the above-mentioned solution may be further subjected to a washing treatment with water and a drying treatment. The drying treatment may be performed at a temperature of 150° C. or lower for 1 to 24 hours.

The method for forming the separation functional layer 1 is not limited to the above-mentioned method. The separation functional layer 1 may be formed by applying the coating liquid containing the polyimide P and the solvent mentioned above onto the substrate and drying the coating liquid. Alternatively, the separation functional layer 1 may be formed by applying onto the substrate the coating liquid containing polyamide acid that is the precursor of the polyimide P and imidizing the polyamide acid to form the polyimide P.

The formed separation functional layer 1 may further be subjected to a heat treatment (annealing treatment). This treatment tends to improve the separation performance of the separation functional layer 1 and also make it possible to suppress the time-dependent deterioration of the separation performance of the separation functional layer 1. This treatment also makes it possible to obtain the separation functional layer 1 that hardly includes a residual solvent because the solvent sufficiently evaporates.

The heat treatment temperature is, for example, higher than 200° C., and may be 230° C. or higher, or even 250° C. or higher. The upper limit of the heat treatment temperature is, for example, but not particularly limited to, 350° C. or lower, and may be 300° C. or lower. The heat treatment time is, for example, 1 minute or longer, and may be 10 minutes or longer or 30 minutes or longer. The upper limit of the heat treatment time is, for example, but not particularly limited to, 24 hours or less.

Next, a coating liquid containing the materials of the intermediate layer 2 is applied onto the separation functional layer 1 and further dried to form the intermediate layer 2. The coating liquid containing the materials of the intermediate layer 2 is typically the above-mentioned pressure-sensitive adhesive composition. As the method for applying the coating liquid, the method stated above for the separation functional layer 1 can be mentioned. A coating film is formed by applying the coating liquid onto the separation functional layer 1. The coating film is dried to form the intermediate layer 2. The coating film can be dried under a heating condition. In one example, when the coating liquid is the addition reaction-type silicone-based pressure-sensitive adhesive, the coating film may be heated at 100 to 130° C. to be dried.

Preferably, a crosslinking reaction of the silicone-based polymer proceeds to form a crosslinked product of the silicone-based polymer while the coating film is being dried under the heating condition mentioned above. The heating time of the coating film is, for example, one minute or longer, and may be five minutes or longer. By drying the coating film, it is possible to obtain a laminate having the substrate, the separation functional layer 1, and the intermediate layer 2 in this order. The intermediate layer 2 in this laminate is exposed to an outside of the laminate.

Next, the intermediate layer 2 of the above-mentioned laminate is attached to the porous support member 3. The method for attaching the intermediate layer 2 to the porous support member 3 is not particularly limited and a known method can be used. For example, the intermediate layer 2 is laid on the porous support member 3 and a roller is rolled thereon back and forth so that they are press-bonded, and thereby the intermediate layer 2 can be attached to the porous support member 3. The separation membrane 10 can be obtained by removing the substrate from the obtained laminate.

Conventionally, a separation membrane is formed by applying a coating liquid containing materials of an intermediate layer onto a porous support member to form an intermediate layer and then further forming a separation functional layer on the intermediate layer (Patent Literature 1, for example). In this method, in order to inhibit the coating liquid from entering into the porous support member, pores on a surface, on the intermediate layer side, of the porous support member need to have small diameters. Therefore, this method usually uses a porous support member obtained by stacking a microporous layer on a surface of a nonwoven fabric. However, this porous support member has a large thickness because of the microporous layer disposed.

According to the studies by the present inventors, a transfer method in which a separation functional layer and an intermediate layer are transferred to a porous support member does not require to reduce the diameters of the pores on the surface, on the intermediate layer side, of the porous support member, making it unnecessary to use a porous support member having a microporous layer. In the present embodiment, it is possible to reduce the thickness (the total thickness) of the separation membrane 10 by using the porous support member 3 having no microporous layer. The separation membrane 10 with a small thickness makes it possible to increase easily the membrane area of the separation membrane 10 that can be mounted in a membrane separation device (particularly a spiral membrane element). Accordingly, it can be said that the separation membrane 10 of the present embodiment is suitable for a membrane separation device (particularly a spiral membrane element). In addition, use of the porous support member 3 having no microporous layer tends to make it possible to produce the separation membrane 10 at a low cost.

### (Shape of Separation Membrane)

In the present embodiment, the separation membrane 10 is typically a flat membrane. However, the separation membrane 10 may have a shape other than a flat membrane shape, and it may be a hollow fiber membrane.

In the present embodiment, the porous support member 3 tends to have a small thickness and the separation membrane 10 also tends to have a small thickness. The thickness of the separation membrane 10 is, for example, 135 μm or less, and may be 130 μm or less, 120 μm or less, 110 μm or less, 100 μm or less, 90 μm or less, 80 μm or less, or even 70 μm or less. The lower limit of the thickness of the separation membrane 10 is, for example, 20 μm or more, and may be 30 μm or more, 40 μm or more, or even 50 μm or more.

### (Characteristics of Separation Membrane)

The separation membrane 10 tends to have a high pressure resistance by including the porous support member 3. In one example, a retention ratio of a separation factor α of the separation membrane 10 is 70% or more when the separation membrane 10 is exposed, for 5 minutes, to nitrogen having a pressure of 2.0 MPa. Here, the separation factor α refers to a ratio T_{CO2}/T_{N2} of a permeance T_{CO2} (GPU) of carbon dioxide permeating through the separation membrane 10 when carbon dioxide having a pressure of 0.6 MPa is supplied to a space adjacent to one surface of the separation membrane 10 with respect to a permeance T_{N2} (GPU) of nitrogen permeating through the separation membrane 10 when nitrogen having a pressure of 0.6 MPa is supplied to the space.

To the knowledge of the present inventors, there has been known no separation membrane that has a thickness of 130 μm or less and in which the retention ratio of the above-mentioned separation factor α is 70% or more.

In another aspect, the present invention provides the separation membrane 10 including:
the separation functional layer 1;
the porous support member 3 supporting the separation functional layer 1; and
the intermediate layer 2 disposed between the separation functional layer 1 and the porous support member 3, wherein
the separation membrane 10 has a thickness of 130 μm or less, and
the retention ratio of the separation factor α of the separation membrane 10 is 70% or more when the separation membrane 10 is exposed, for 5 minutes, to nitrogen having a pressure of 2.0 MPa.

Specifically, the above-mentioned retention ratio of the separation factor α can be determined by the following method. First, the separation membrane 10 in an initial state is stacked on a permeation spacer (#1000 available from KB SEIREN LTD.) to produce a specimen. In the specimen, the permeation spacer is positioned on the porous support member 3 side of the separation membrane 10. The specimen is placed in a metal cell, and the metal cell is sealed with an O-ring so that no leakage would occur. Next, nitrogen is injected into the metal cell in such a manner that one main surface (a main surface 11 on the separation functional layer side) of the separation membrane 10 is exposed to the nitrogen. The nitrogen has a temperature of 30° C. and a pressure of 0.6 MPa. As a result, a permeated fluid (nitrogen) that has permeated through the separation membrane 10 is obtained from another main surface (a main surface 12) of the separation membrane 10. The flow rate of the permeated fluid is measured with a mass flow meter, and a permeance T_{N2} (GPU) of nitrogen in the initial state is determined from the obtained result.

Next, carbon dioxide is injected into the metal cell in such a manner that the above-mentioned main surface 11 is exposed to the carbon dioxide. The carbon dioxide has a temperature of 30° C. and a pressure of 0.6 MPa. Thereby, a permeated fluid (carbon dioxide) having permeated through the separation membrane 10 can be obtained from the above-mentioned main surface 12. The flow rate of the permeated fluid is measured with a mass flow meter, and a permeance T_{CO2} (GPU) of carbon dioxide in the initial state is determined from the obtained result. The ratio T_{CO2}/T_{N2} of the permeance T_{CO2} (GPU) with respect to the permeance T_{N2} (GPU) in the initial state is determined as the separation factor α1 in the initial state.

Next, the separation membrane 10 is subjected to a pressure test. Specifically, nitrogen is injected into the metal cell in such a manner that the above-mentioned main surface 11 is exposed to the nitrogen. In the pressure test, the nitrogen has a temperature of 30° C. and a pressure of 2.0 MPa. The pressure test exposes the separation membrane 10, for 5 minutes, to the nitrogen having a pressure of 2.0 MPa. As for the separation membrane 10 (the specimen) after the pressure test, a permeance T_{N2} (GPU) and a permeance T_{CO2} (GPU) are determined by the same method mentioned above. The ratio T_{CO2}/T_{N2} of the permeance T_{CO2} (GPU) with respect to the permeance T_{N2} (GPU) after the pressure test is determined as a separation factor α2 after the pressure test.

Next, a ratio α2/α1 of the separation factor α2 after the pressure test with respect to the separation factor α1 in the initial state is calculated. The calculated value obtained can be regarded as the retention ratio of the separation factor a.

The retention ratio of the separation factor α is preferably 80% or more, and may be 85% or more, 90% or more, 95% or more, or even 98% or more. The upper limit of the retention ratio of the separation factor α is, for example, 120% or less, and may be 115% or less, 110% or less, or even 100% or less.

The permeance T_{CO2} of carbon dioxide in the initial state is, for example, 10 GPU or more, and may be 20 GPU or more, 30 GPU or more, 40 GPU or more, 50 GPU or more, 60 GPU or more, or even 70 GPU or more. The upper limit of the permeance T_{CO2} in the initial state is not particularly limited because the higher it is, the more preferable it is, but it may be 2000 GPU or less, for example. The permeance T_{N2} of nitrogen in the initial state is, for example, 50 GPU or less, and may be less than 10 GPU. GPU means 10⁻⁶·cm³(STP)/(sec·cm²·cmHg). The symbol “cm³(STP)” means the volume of carbon dioxide at 1 atmospheric pressure and 0° C.

The separation factor α1 (the ratio T_{CO2}/T_{N2}) in the initial state is, for example, 10 or more, and may be 11 or more, 12 or more, 13 or more, 14 or more, 15 or more, 16 or more, 17 or more, or even 18 or more. The upper limit of the separation factor α1 is, for example, 100 or less, and may be 50 or less.

The permeance T_{CO2} of carbon dioxide after the pressure test is, for example, 10 GPU or more, and may be 20 GPU or more, 30 GPU or more, 40 GPU or more, 50 GPU or more, 60 GPU or more, or even 70 GPU or more. The upper limit of the permeance T_{CO2} after the pressure test is not particularly limited because the higher it is, the more preferable it is, but it may be 2000 GPU or less, for example. The permeance T_{N2} of nitrogen after the pressure test is, for example, 50 GPU or less, and may be less than 10 GPU.

The separation factor α2 (the ratio T_{CO2}/T_{N2}) after the pressure test is, for example, 10 or more, and may be 12 or more, 14 or more, 15 or more, 17 or more, or even 20 or more. The upper limit of the separation factor α2 is, for example, 100 or less, and may be 50 or less.

The separation membrane 10 tends to have a high tensile strength by including the porous support member 3. The separation membrane 10 with a high tensile strength tends to have a high retention ratio of the separation factor α. In one example, a tensile strength Y_{MD} of the separation membrane 10 in an MD direction (a machine direction of a production process of the porous support member 3) is, for example, 5.0 N/50 mm or more, and may be 10 N/50 mm or more, 20 N/50 mm or more, 30 N/50 mm or more, 50 N/50 mm or more, 80 N/50 mm or more, 100 N/50 mm or more, or even 150 N/50 mm or more. The upper limit of the tensile strength Y_{MD} is, for example, 500 N/50 mm or less.

Furthermore, a tensile strength Y_{CD} of the separation membrane 10 in a CD direction (a direction perpendicular to the MD direction) is, for example, 5.0 N/50 mm or more, and may be 10 N/50 mm or more, 20 N/50 mm or more, 30 N/50 mm or more, or even 50 N/50 mm or more. The upper limit of the tensile strength Y_{CD} is, for example, 500 N/50 mm or less.

The tensile strength Y_{MD} can be measured by the following method. First, the separation membrane 10 is cut to have a length of 70 mm in the MD direction and a length of 70 mm in the CD direction to obtain a specimen. The specimen is placed in a tensile testing machine in such a manner that two chucks are arranged in an MD direction of the specimen. A maximum stress when the specimen is subjected to a tensile test under the conditions that the distance between the chucks is 50 mm and the tensile rate is 100 mm/min can be regarded as the tensile strength Y_{MD}. The tensile strength Y_{CD} can be measured in the same manner as for the tensile strength Y_{MD}, except that the specimen is placed in the tensile testing machine in such a manner that the two chucks are arranged in a CD direction of the specimen.

### (Use of Separation Membrane)

As a use of the separation membrane 10 of the present embodiment, there can be mentioned the use for separating an acid gas from a gas mixture containing the acid gas. Examples of the acid gas in the gas mixture include carbon dioxide, hydrogen sulfide, carbonyl sulfide, sulfur oxide (SOx), hydrogen cyanide, and nitrogen oxide (NOx), and preferred is carbon dioxide. The gas mixture contains an additional gas other than the acid gas. Examples of the additional gas include a nonpolar gas such as hydrogen, nitrogen, or methane, and an inert gas such as helium, and preferred examples include nitrogen and methane. Particularly, the separation membrane 10 of the present embodiment is suitably used for separating carbon dioxide from a gas mixture containing carbon dioxide and nitrogen. However, the use of the separation membrane 10 is not limited to the use for separating an acid gas from the above-mentioned gas mixture.

### <Embodiment of Membrane Separation Device>

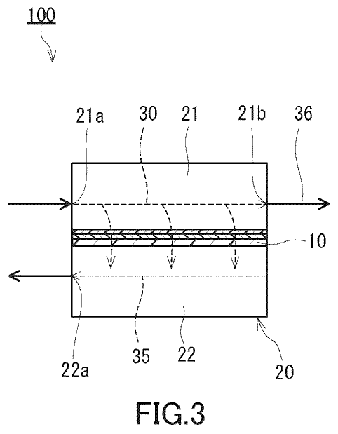

As shown in FIG. 3, a membrane separation device 100 of the present embodiment includes the separation membrane 10 and a tank 20. The tank 20 includes a first chamber 21 and a second chamber 22. The separation membrane 10 is disposed in the tank 20. In the tank 20, the separation membrane 10 separates the first chamber 21 and the second chamber 22 from each other. The separation membrane 10 extends from one of a pair of wall surfaces of the tank 20 to the other.

The first chamber 21 has an inlet 21a and an outlet 21b. The second chamber 22 has an outlet 22a. Preferably, the inlet 21a, the outlet 21b, and the outlet 22a are each an opening provided in a wall surface of the tank 20.

Membrane separation using the membrane separation device 100 is performed by the following method. First, a gas mixture 30 containing an acid gas is supplied to the first chamber 21 via the inlet 21a. The concentration of the acid gas in the gas mixture 30 is, for example, but not particularly limited to, 0.01 vol % (100 ppm) or more, preferably 1 vol % or more, more preferably 10 vol % or more, still more preferably 30 vol % or more, and particularly preferably 50 vol % or more, under standard conditions. The upper limit of the concentration of the acid gas in the gas mixture 30 is, for example, but not particularly limited to, 90 vol % under standard conditions.

The pressure in the first chamber 21 may be increased by supplying the gas mixture 30. The membrane separation device 100 may further include a pump (not shown) for increasing the pressure of the gas mixture 30. The pressure of the gas mixture 30 to be supplied to the first chamber 21 is, for example, 0.1 MPa or more, and preferably 0.3 MPa or more.

The pressure in the second chamber 22 may be decreased while the gas mixture 30 is supplied to the first chamber 21. The membrane separation device 100 may further include a pump (not shown) for decreasing the pressure in the second chamber 22. The pressure in the second chamber 22 may be decreased such that a space in the second chamber 22 has a pressure lower than an atmospheric pressure in a measurement environment by, for example, 10 kPa or more, preferably 50 kPa or more, and more preferably 100 kPa or more.

Supply of the gas mixture 30 to the first chamber 21 allows to obtain, on the other surface side of the separation membrane 10, a permeated fluid 35 in which the acid gas content is higher than in the gas mixture 30. That is, the permeated fluid 35 is supplied to the second chamber 22. The permeated fluid 35 preferably contains the acid gas as a main component. The permeated fluid 35 may contain a small amount of a gas other than the acid gas. The permeated fluid 35 is discharged outside the tank 20 via the outlet 22a.

The concentration of the acid gas in the gas mixture 30 gradually decreases from the inlet 21a toward the outlet 21b in the first chamber 21. The gas mixture 30 processed in the first chamber 21 (a non-permeated fluid 36) is discharged outside the tank 20 via the outlet 21b.

The membrane separation device 100 of the present embodiment is suitable for flow (continuous) membrane separation. The membrane separation device 100 of the present embodiment may be used for batch membrane separation.

### <Modification of Membrane Separation Device>

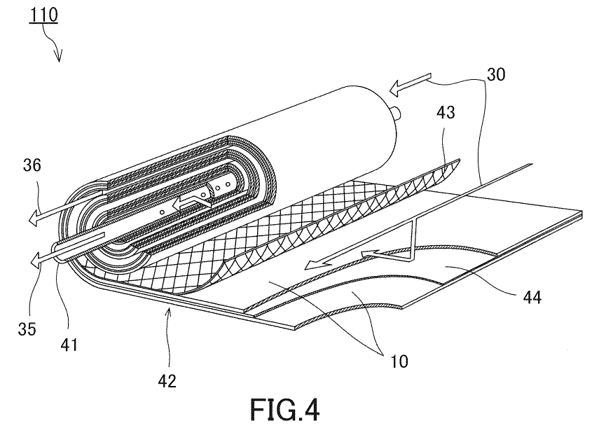

The membrane separation device 100 may be a spiral membrane element, a hollow fiber membrane element, or the like. FIG. 4 shows a spiral membrane element. A membrane separation device 110 of FIG. 4 includes a central tube 41 and a laminate 42. The laminate 42 includes the separation membrane 10.

The central tube 41 has a cylindrical shape. The central tube 41 has, in its surface, a plurality of holes for allowing the permeated fluid 35 to flow into the central tube 41. Examples of a material of the central tube 41 include: a resin such as an acrylonitrile-butadiene-styrene copolymer resin (ABS resin), a polyphenylene ether resin (PPE resin), or a polysulfone resin (PSF resin); and a metal such as stainless steel or titanium. The central tube 41 has an inner diameter in the range of 20 to 100 mm, for example.

The laminate 42 further includes a feed-side flow passage material 43 and a permeation-side flow passage material 44 in addition to the separation membrane 10. The laminate 42 is wound around the central tube 41. The membrane separation device 110 may further include an exterior material (not shown).

For example, a resin net composed of polyphenylene sulfide (PPS) or an ethylene-chlorotrifluoroethylene copolymer (ECTFE) can be used as the feed-side flow passage material 43 and the permeation-side flow passage material 44.

Membrane separation using the membrane separation device 110 is performed by the following method. First, the gas mixture 30 is supplied into one end of the wound laminate 42. The permeated fluid 35 that has permeated through the separation membrane 10 of the laminate 42 moves into the central tube 41. The permeated fluid 35 is discharged outside via the center tube 41. The gas mixture 30 processed by the membrane separation device 110 (the non-permeated fluid 36) is discharged outside from another end of the wound laminate 42. Thus, the acid gas can be separated from the gas mixture 30.

### EXAMPLES

Hereinafter, the present invention will be described in more detail by way of Examples and Comparative Example, but the present invention is not limited to these examples.

### Example 1

### [Synthesis of Polyimide]

First, polyimide was synthesized using an automatic polymerization apparatus (EasyMax 402 available from METTLER TOLEDO). A separable flask (400 mL volume) coming with the apparatus was equipped with a Dimroth condenser, a stirring rod, a bulk thermometer, a nitrogen introducing tube, and a flat stopper. A cooling fluid set at 10° C. was circulated through a chiller of the Dimroth condenser. A N₂ gas was made to flow inside the flask at a flow rate of 100 mL/min. The stirring rate was set at 300 rpm. Next, 96.1 g of 1-methyl-2-pyrrolidone (super-dehydrated) as a solvent, and 2.62 g (17.5 mmol) of 2,4,6-trimethyl-1,3-phenylenediamine (TrMPD), 4.80 g (17.5 mmol) of 3,7-diamino-2,8-dimethyldibenzothiophene sulfone (DDBT), and 2.11 g (0.5 mmol) of 5,5′-methylenebis(2-aminobenzoic acid) (MBAA), each as diamine, were added into the flask. They were stirred at a room temperature to dissolve the diamine in the solvent. To the obtained solution, 9.53 g (35.5 mmol) of naphthalene-1,4,5,8-tetracarboxylic dianhydride (NTDA) as a tetracarboxylic dianhydride and 8.54 g (70 mmol) of benzoic acid were further added. The temperature of the jacket of the apparatus was raised to 180° C. and the mixture was stirred for 8 hours. At that time, the inner temperature of the flask was 172 to 175° C. After the stirring, the inner temperature of the flask was cooled to 25° C., and the flask was left at rest overnight.

Next, 9.04 g (70 mmol) of isoquinoline was added thereto, the temperature of the jacket was raised to 180° C. again, and the resultant was stirred for 8 hours. The reaction solution was left at rest overnight, and then 226 g of 1-methyl-2-pyrrolidone was added to dilute the reaction solution. Next, 650 mL of methanol was dropped to the reaction solution over about 30 minutes using a dropping funnel to perform reprecipitation purification. An operation of filtering out the deposited polyimide and washing the polyimide with 300 mL of methanol was performed two times. After the washing, the polyimide filtered out was dried by a hot air circulation dryer at 60° C. for 15 hours, and further dried by a vacuum dryer at 100° C. for 8 hours. Thereby, polyimide was obtained in a yield of 17.1 g.

### [Production of Separation Functional Layer]

Next, the polyimide was put in a 50 mL screw tube, and N-methyl-2-pyrrolidone (NMP) as a solvent and acetylacetone as a ligand were further added thereto to obtain a mixed solution. This mixed solution was subjected to a 5-minute stirring operation as well as a 5-minute defoaming operation twice. Next, NMP and Al(acac)₃ as the metal complex were put in a separate screw tube, and furthermore the resultant was subjected to an ultrasonic treatment using an ultrasonic washing machine to obtain an Al(acac)₃ solution. The Al(acac)₃ solution was mixed further with the above-mentioned mixed solution and the resultant was subjected to a 5-minute stirring operation as well as a 5-minute defoaming operation twice to prepare a coating liquid containing polyimide. The stirring operations and the defoaming operations were conducted using Awatori Rentaro available from THINKY CORPORATION. The content of the polyimide in the coating liquid was 8 wt %.

Next, the above-mentioned coating liquid was applied onto a polyimide film (SCAO available from FUJIKO Co., Ltd.) subjected to a release treatment to produce a coating film (with a thickness of 30 μm). The coating film was heated at 130° C. for 10 minutes to obtain a separation functional layer having a thickness of 2 μm. The drying of the coating film allowed a dissociative proton of the functional group g (carboxyl group) included in the polyimide to be replaced with the Al of the metal complex. Thereby, an Al salt of the functional group g was formed.

Next, a silicone-based pressure-sensitive adhesive (KR-3701 available from Shin-Etsu Silicone) was diluted with toluene to prepare a coating liquid with a solid content concentration of 6 wt %. The coating liquid was applied onto the separation functional layer to produce a coating film (with a thickness of 100 μm). The coating film was dried at 130° C. for 3 minutes to form an intermediate layer with a thickness of 3 μm. Thereby, a laminate having the polyimide film, the separation functional layer, and the intermediate layer in this order was obtained.

Next, the intermediate layer of the above-mentioned laminate was laid on a porous support member and they were press-bonded under the condition of 0.3 MPa and 1 m/min. As the porous support member, a PET nonwoven fabric (N401 available from AWA PAPER & TECHNOLOGICAL COMPANY, Inc.) was used. Next, a double-sided tape was applied on a surface of the polyimide film and the polyimide film was fixed to a support. Furthermore, a tape was applied on a surface of the porous support member and this tape was held to peel off slowly the laminate of the separation functional layer, the intermediate layer, and the porous support member from the polyimide film. Thereby, a separation membrane of Example 1 was obtained.

### Examples 2 to 5

A separation membrane of each of Examples 2 to 5 was obtained in the same manner as in Example 1, except that the type of the porous support member and the thickness of each layer were changed as shown in Table 1.

### Example 6

First, a separation functional layer with a thickness of 4 μm was formed on the polyimide film in the same manner as in Example 1. The separation functional layer was peeled off from the polyimide film to obtain a separation membrane of Example 6 composed only of the separation functional layer.

### [Physical Properties of Porous Support Member]

### (ISO Air Permeability)

The porous support member used for producing the separation membrane was measured for ISO air permeability in accordance with the Oken-type tester method prescribed in JIS P8117:2009. The ISO air permeability was measured using EGO1, a digital Oken-type air permeability tester (available form ASAHI SEIKO CO., LTD) under the conditions that the measurement pressure was 0.05 MPa and the measurement time was 60 seconds.

### (Load Area Ratio Smr(C₁))

The surface, on the intermediate layer side, of the porous support member used for producing the separation membrane was subjected to the three-dimensional analysis by the above-mentioned method with a laser microscope to obtain a load curve. As the laser microscope, OPTELICS, a hybrid laser microscope available from Lasertec Corporation was used and M-PLAN APO 50× available from Mitutoyo Corporation was used as an object lens. Using the obtained load curve, a height c₁ whose difference from a height c₀ at a load area ratio of 0% is equal to the thickness of the intermediate layer was determined, and the load area ratio Smr(c₁) corresponding to the height c₁ was determined.

### [Peel Strength]

A layer having the same composition and thickness as those of the intermediate layer included in the separation membrane was formed on the evaluation sheet by the above-mentioned method, and the peel strength between the intermediate layer and the porous support member was measured.

### [Physical Properties of Separation Membrane]

### (Tensile Strength)

The produced separation membrane was measured for the tensile strength Y_{MD} in the MD direction and the tensile strength Y_{CD} in the CD direction by the above-mentioned method. As the tensile testing machine, Autograph AGX-V available from Shimadzu Corporation was used.

### (Retention Ratio of Separation Factor α)

The produced separation membrane was measured for the permeance T_{N2} (GPU) of nitrogen and the permeance T_{CO2} (GPU) of carbon dioxide in the initial state by the above-mentioned method, and the ratio T_{CO2}/T_{N2} was determined as the separation factor α1 in the initial state. In addition, the pressure test was conducted by the above-mentioned method to measure the permeance T_{N2} (GPU) of nitrogen and the permeance T_{CO2} (GPU) of carbon dioxide after the pressure test, and the ratio T_{CO2}/T_{N2} was determined as the separation factor α2 after the pressure test. The ratio α2/α1 of the separation factor α2 after the pressure test with respect to the separation factor α1 in the initial state was calculated, and the calculated value was regarded as the retention ratio of the separation factor α.

TABLE 1

| | Separation | | | | Porous support member | | | | Peel | | |
|---|---|---|---|---|---|---|---|---|---|---|---|
| | functional layer | | Intermediate layer | | | | ISO air | Load area | strength | Transfer | Total |
| | | Thickness | | Thickness | | Thickness | permeability | ratio | [N/25 mm] | property | thickness |
| | Material | [μm] | Material | [μm] | Type | [μm] | [μm/(Pa · s)] | Smr(c₁) [%] | (*1) | (*2) | [μm] |
| Example | PI | 2 | Si | 3 | N401 | 59.2 | 19.9 × 10⁴ | 0.22 | 2.47 | ∘ | 64.2 |
| 1 | | | pressure- | | | | | | | | |
| | | | sensitive | | | | | | | | |
| | | | adhesive | | | | | | | | |
| Example | PI | 2 | Si | 3 | S54 | 92.12 | 46.1 × 10⁴ | 0.07 | 2.40 | ∘ | 97.1 |
| 2 | | | pressure- | | | | | | | | |
| | | | sensitive | | | | | | | | |
| | | | adhesive | | | | | | | | |
| Example | PI | 2 | Si | 3 | N301 | 98.2 | 36.1 × 10⁴ | 0.11 | 0.67 | ∘ | 103.2 |
| 3 | | | pressure- | | | | | | | | |
| | | | sensitive | | | | | | | | |
| | | | adhesive | | | | | | | | |
| Example | PI | 2 | Si | 1 | N301 | 98.2 | 36.1 × 10⁴ | 0.04 | 0.54 | ∘ | 101.1 |
| 4 | | | pressure- | | | | | | | | |
| | | | sensitive | | | | | | | | |
| | | | adhesive | | | | | | | | |
| Example | PI | 2 | Si | 3 | PS0100S-thin | 124.4 | 132.3 × 10⁴ | 0.88 | 1.25 | ∘ | 129.4 |
| 5 | | | pressure- | | | | | | | | |
| | | | sensitive | | | | | | | | |
| | | | adhesive | | | | | | | | |
| Example | PI | 4 | — | — | — | — | — | — | — | — | 4.0 |
| 6 | | | | | | | | | | | |

(*1) The peel strength between the intermediate layer and the porous support member.
(*2) ∘: The separation membrane was able to be produced by the transfer method.
x: The separation membrane failed to be produced by the transfer method.

TABLE 2

| | | | Separation characteristics | | | | | | |
|---|---|---|---|---|---|---|---|---|---|
| | | | In initial state | | | After pressure test | | | Retention |
| | Tensile strength | | | | Separation | | | Separation | ratio |
| | Y_{MD} | Y_{CD} | Permeance | Permeance | factor α1 | Permeance | Permeance | factor α2 | α2/α1 |
| | [N/50 mm] | [N/50 mm] | T_{N2} [GPU] | T_{CO2} [GPU] | [—] | T_{N2} [GPU] | T_{CO2} [GPU] | [—] | [%] |
| Example | 27.9 | 7.9 | 0.8 | 13.3 | 16.6 | 0.9 | 17.4 | 18.5 | 112 |
| 1 | | | | | | | | | |
| Example | 30.6 | 11.5 | 1.9 | 31.0 | 16.3 | 2.7 | 40.5 | 14.9 | 92 |
| 2 | | | | | | | | | |
| Example | 20.6 | 10.3 | 3.5 | 52.1 | 15.1 | 4.0 | 60.0 | 14.9 | 99 |
| 3 | | | | | | | | | |
| Example | 20.6 | 10.3 | 5.7 | 72.4 | 12.8 | 5.7 | 85.8 | 15.1 | 118 |
| 4 | | | | | | | | | |
| Example | 155.2 | 62.9 | 2.4 | 44.3 | 18.3 | 2.7 | 56.0 | 21.0 | 115 |
| 5 | | | | | | | | | |
| Example | — | — | 2.6 | 34.6 | 13.2 | 1545.0 | 1620.0 | 1.0 | 8 |
| 6 | | | | | | | | | |

Abbreviations in Table 1 are as follows.
N401: PET nonwoven fabric (N401 available from AWA PAPER & TECHNOLOGICAL COMPANY, Inc.)
S54: PET nonwoven fabric (S54 available from Hokuetsu Corporation)
N301: PET nonwoven fabric (N301 available from AWA PAPER & TECHNOLOGICAL COMPANY, Inc.)
PS0100S-thin: PPS nonwoven fabric (PS0100S-thin available from HIROSE PAPER MFG. CO., LTD.)

As understood from Tables 1 and 2, in Examples 1 to 5 in which the surface that the porous support member had and that faced the intermediate layer had a load area ratio Smr(c₁) of less than 80%, it was possible to reduce the thickness of the separation membrane. According to the separation membrane of each of Examples 1 to 5, it is possible to increase easily the membrane area of a separation membrane that can be mounted in a membrane separation device (particularly a spiral membrane element), and thus it can be said that the separation membrane is suitable for the membrane separation device.

Furthermore, the separation membrane of each of Examples 1 to 5 had a higher retention ratio of the separation factor α and a higher pressure resistance than those of the separation membrane of Example 6 that did not include the porous support member.

Note that the separation membrane of each of Examples 1 to 5 had 10 GPU or more of the permeance T_{CO2} of carbon dioxide and 10 or more of the separation factor α1 in the initial state, both of which were practically sufficient values.

### INDUSTRIAL APPLICABILITY

The separation membrane of the present embodiment is suitable for separating an acid gas from a gas mixture containing the acid gas. In particular, the separation membrane of the present embodiment is suitable for separating carbon dioxide from an off-gas from a chemical plant or a thermal power plant.

1. A separation membrane comprising:
a separation functional layer;
a porous support member supporting the separation functional layer; and
an intermediate layer disposed between the separation functional layer and the porous support member, wherein
the porous support member has a surface S1 facing the intermediate layer, and
a load area ratio Smr(c₁) of the surface S1 determined by a test below is less than 80%.
Test: The surface S1 of the porous support member is subjected to a three-dimensional analysis to obtain a load curve prescribed in Japanese Industrial Standards (JIS) B0681-2:2018. On the load curve, a height c₁ whose difference from a height c₀ at a load area ratio of 0% is equal to a thickness of the intermediate layer is determined. A load area ratio corresponding to the height c₁ is read and determined as the load area ratio Smr(c₁).

2. The separation membrane according to claim 1, wherein the load area ratio Smr(c₁) is 0.04% or more.

3. The separation membrane according to claim 1, having a thickness of 130 μm or less.

4. A separation membrane comprising:
a separation functional layer;
a porous support member supporting the separation functional layer; and
an intermediate layer disposed between the separation functional layer and the porous support member, wherein
the separation membrane has a thickness of 130 μm or less, and
a retention ratio of a separation factor α of the separation membrane is 70% or more when the separation membrane is exposed, for 5 minutes, to nitrogen having a pressure of 2.0 MPa,
the separation factor α referring to a ratio T_{CO2}/T_{N2} of a permeance T_{CO2} (GPU) of carbon dioxide permeating through the separation membrane when carbon dioxide having a pressure of 0.6 MPa is supplied to a space adjacent to one surface of the separation membrane with respect to a permeance T_{N2} (GPU) of nitrogen permeating through the separation membrane when nitrogen having a pressure of 0.6 MPa is supplied to the space.

5. The separation membrane according to claim 1, wherein the porous support member is a fiber structure.

6. The separation membrane according to claim 1, wherein the porous support member has a thickness of 125 μm or less.

7. The separation membrane according to claim 1, wherein the porous support member has an ISO air permeability of 10.0×10⁴ μm/(Pa·s) or more.

8. The separation membrane according to claim 1, wherein the separation functional layer includes polyimide.

9. The separation membrane according to claim 8, wherein the polyimide includes a structural unit derived from a tetracarboxylic dianhydride having a six-membered ring acid anhydride structure.

10. The separation membrane according to claim 9, wherein the structural unit is represented by formula (A1) below: 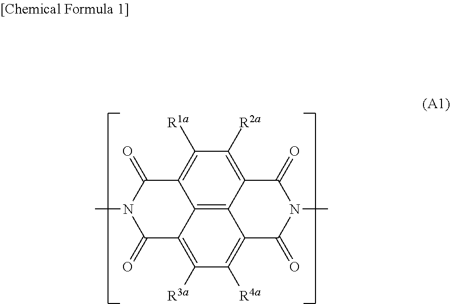
where R^{1a} to R^{4a} are each independently a hydrogen atom or an optional substituent.

11. The separation membrane according to claim 1, wherein the separation functional layer has a thickness of 5.0 μm or less.

12. The separation membrane according to claim 1, wherein the intermediate layer is formed from a pressure-sensitive adhesive composition.

13. The separation membrane according to claim 12, wherein the pressure-sensitive adhesive composition includes a silicone-based polymer.

14. The separation membrane according to claim 1, wherein the intermediate layer has a thickness of 5.0 μm or less.

15. The separation membrane according to claim 1, wherein a peel strength between the intermediate layer and the porous support member is 0.25 N/25 mm or more.
